(19) United States
(12) Patent Application Publication
(10) Pub. No.: US 2011/0050738 A1
(43) Pub. Date: Mar. 3, 2011

(54) LIQUID CRYSTAL DISPLAY DEVICE AND IMAGE PROCESSING METHOD IN LIQUID CRYSTAL DISPLAY DEVICE

(76) Inventors: Kazuyoshi Fujioka, Osaka (JP); Tomoo Furukawa, Osaka (JP)

(21) Appl. No.: 12/735,417

(22) PCT Filed: Oct. 29, 2008
(86) PCT No.: PCT/JP2008/069669

§ 371 Date: Jul. 14, 2010

(30) Foreign Application Priority Data
Feb. 27, 2008 (JP) 2008-046871

(51) Int. Cl. G09G 5/10; G09G 3/36

(52) U.S. Cl. 345/690; 345/87

(57) ABSTRACT

A liquid crystal display device of at least one embodiment of the present invention causes an image to be displayed on a display panel in response to an image signal including image data (first image data) for warning display and image data (second image data) for general display. The image data for warning display has a gradation value exclusively used for the image data for warning display. The liquid crystal display device of at least one embodiment includes an image data identification section which identifies a type of image data by judging whether or not the image data has the gradation value exclusively used for the image data for warning display; and a gradation calculator (gradation conversion section) which carries out a conversion of gradation value with respect to the image data so that luminance of a displayed image is reduced in a case where ambient brightness declines.

### TECHNICAL FIELD

The present invention relates to (i) a liquid crystal display device which is mainly provided in a vehicle and which displays various kinds of information, and (ii) an image processing method in such a liquid crystal display device.

### BACKGROUND ART

In recent years, as a display device for an instrument panel of a vehicle, a digital image display device such as a liquid crystal display device has been used as well as a conventional analog gauge. Such a digital image display device has an advantage that display design and layout can be set freely. On this account, such a digital image display device has been increasingly used in recent years in a vehicle in replacement of a conventional analog gauge.

In the nighttime, i.e., in a case where there is a large difference in brightness between an outside of a vehicle and an in-vehicle apparatus for displaying various meters, a driver who sees the outside after looking at the bright meters temporarily has poor visibility towards the outside. This threatens safety of the driver. In order to secure safety of the driver, brightness of the display apparatus for displaying various meters needs to be suppressed, in the nighttime, to a degree that does not affect the driver's visibility towards the outside.

In view of this, in a digital display device such as a liquid crystal display device, brightness of an entire display screen is adjusted by adjusting luminance of a backlight. For example, in the nighttime, various kinds of information are displayed while the entire display screen is being slightly darkened by reducing the luminance of the backlight.

A display device for use in a vehicle displays various information including (i) meter-related information such as speed and fuel value, (ii) car navigation information, and (iii) warning information such as ON/OFF state of a blinker etc., warning for a half-shut state, and malfunction of equipments provided in a vehicle. Above all, the warning information needs to be recognized by a driver any time day or night.

However, in a case where brightness of an entire display screen is adjusted by adjusting luminance of a backlight as above, warning information is displayed at the same brightness level as the other information. Accordingly, in a case where the entire display screen is darkened in the nighttime, the warning information is also darkened. This makes the warning information hard to be recognized by a driver.

In view of this, Patent Literature 1 discloses an alternative method to the method of adjusting brightness of a display screen by adjusting luminance of a backlight. According to the method disclosed in Patent Literature 1, brightness of a display screen is adjusted such that the maximum gradation value for general display (i.e. display other than warning display) is lowered (i.e., the number of gradations for the general display is reduced) in a case where it is desired that the brightness of the display screen be reduced. Meanwhile, the maximum gradation value for the warning display is not changed regardless of a change in brightness of the display screen. Thus, visibility of the warning display is maintained.

### Citation List

Patent Literature 1

Japanese Patent Application Publication, Tokukai, No. 2007-91030 A (Publication Date: Apr. 12, 2007)

Patent Literature 2

Japanese Patent Application Publication, Tokukai, No. 2005-10520 A (Publication Date: Jan. 13, 2005)

Patent Literature 3

Japanese Patent Application Publication, Tokukai, No. 2001-337667 A (Publication Date: Dec. 7, 2001)

### SUMMARY OF INVENTION

However, since according to an in-vehicle display device disclosed in Patent Literature 1, the maximum gradation value is lowered for the purpose of adjusting brightness, the number of gradations is reduced. This causes some of the gradations to overlap each other (i.e., so-called tone jump), thereby causing a reduction in image quality.

Such occurrence of the tone jump can be suppressed, for example, by carrying out pseudo multi-gradation processing (see Patent Literatures 2 and 3, for example). In a case where image processing utilizing pseudo multi-gradation processing disclosed in Patent Literature 2 etc. is applied to the in-vehicle display device disclosed in Patent Literature 1, the pseudo multi-gradation processing needs to be carried out when a signal is transmitted from a video memory to a liquid crystal display panel.

However, unless data for warning display is found out from image data stored in a video memory, the pseudo multi-gradation processing is carried out all of the video data for image display. In this way, simply applying pseudo multi-gradation processing to the display device in which brightness is adjusted by reducing the number of gradations causes a problem that the pseudo multi-gradation processing is also carried out with respect to the data for warning display which need not to be subjected to the pseudo multi-gradation processing.

The present invention was attained in view of the above problems, and an object of the present invention is to provide a technique for a liquid crystal display device in which brightness of a display screen is adjusted by changing the number of gradations, the technique suppressing a decline in image quality of general display and maintaining visibility towards information of high importance such as warning display by maintaining high luminance of the information of high importance.

In order to attain the above object, a liquid crystal display device of the present invention which causes an image to be displayed on a display panel in response to an image signal including first image data for displaying information of high importance and second image data for displaying information other than the information of high importance, the first image data having a gradation value exclusively used for the first image data, includes: an image data identification section which determines whether image data to be processed is the first image data or the second image data by judging whether or not the image data has the gradation value exclusively used for the first image data; and a gradation conversion section which carries out gradation conversion processing with respect to the image data so that luminance of a displayed image is reduced in a case where ambient brightness declines, the gradation conversion section carrying out the gradation conversion processing with respect to image data, which has been determined to be the second image data by the image identification section, so as to reduce the luminance of the image data.

According to the above arrangement, there is provided a gradation value exclusively used for the first image data so that it is possible to distinguish between the first image data and the second image data. Since (i) there is provided a gradation value exclusively used for the first image data and (ii) the gradation value exclusively used for the first image data is not used in the second image data, it is possible to easily distinguish between the first image data and the second image data.

This makes it possible to easily distinguish between the first image data and the second image data while the number of bits is limited to a predetermined one, without causing any increase in circuit size in spite of increasing the number of bits of the image data.

Further, in a case where ambient brightness declines (e.g. in the nighttime), the second image data is subjected to gradation conversion processing for reducing luminance of a displayed image. This allows luminance of a displayed image created based on the second image data to be changed in accordance with a change in ambient brightness. Meanwhile, since the first image data is not subjected to such gradation conversion processing for reducing luminance of a displayed image, luminance of information of high importance can be kept high.

Since it is possible to easily distinguish between the first image data and the second image data, only the second image data can be subjected to image processing, such as pseudo multi-gradation processing, which suppresses a decline in image quality.

The liquid crystal display device of the present invention may be arranged so that the gradation conversion section carries out processing which causes the gradation value of the image data to be shifted to a lower gradation value, said liquid crystal display device, further including: a pseudo multi-gradation processing section which carries out pseudo multi-gradation processing with respect to the second image data in a case where the gradation conversion section carries out the gradation conversion processing with respect to the second image data.

The processing which causes the gradation value of the image data to be shifted to a lower gradation value indicates processing in which (i) the maximum gradation value is shifted from 63 to 46 and (ii) the other gradation values are shifted to respective lower ones accordingly, in the case of 6-bit image data. As a result of reducing the maximum gradation value from 63 to 46, luminance of a displayed image declines by about 50%. Further, the number of available gradations is reduced from 64 (0 through 63) to 47 (0 through 46).

According to the arrangement, the pseudo multi-gradation processing can suppress a decline in gradation expressing capability which decline is caused by a reduction in the number of gradations. This makes it possible to suppress a decline in image quality even in a case where the second image data is subjected to the gradation conversion processing for reducing luminance of a displayed image.

For example, the second image data can be subjected to the following processing as the pseudo multi-gradation processing. Specifically, a driving voltage applied to a liquid crystal element is varied with different frames so that in-between luminance is perceived by a human eye. Such processing is referred to as FRC pseudo multi-gradation processing.

The liquid crystal display device of the present invention is preferably arranged such that a maximum gradation value or a minimum gradation value is used as the gradation value exclusively used for the first image data.

According to the above arrangement, in which the maximum gradation value or the minimum gradation value is used as the gradation values exclusively used for the first image data, it is possible to simplify a data structure of image data. This makes it possible to efficiently carry out the gradation conversion processing with respect to the second image data in which gradation values other than the gradation value exclusively used for the first image data are used. Further, using the maximum gradation value in the first image data increases luminance of an image displayed based on the first image data, thereby making the image more noticeable than an image displayed based on the second image data.

The liquid crystal display device of the present invention may be arranged such that the gradation conversion section selects whether or not it carries out the gradation conversion processing depending on whether said device is in a night mode or in a day mode, and carries out the gradation conversion processing in the night mode.

According to the above arrangement, an image displayed based on the second image data can have reduced luminance in the night mode. The night mode and the day mode are image display modes of the display panel. Switching between the night mode and the day mode is carried out in response to a display mode instruction signal generated, in the device, based on information concerning ambient brightness detected by an illuminance sensor provided in a vehicle or based on ON/OFF of a switch for a front position light or a headlamp, for example.

The liquid crystal display device of the present invention may be arranged such that the liquid crystal display device is for use in a vehicle, and the first image data is image data for warning display.

According to the above arrangement, luminance of an image displayed based on image data for displaying warning information of high importance such as malfunction of an apparatus provided in the vehicle can be kept high regardless of a change in ambient brightness.

The warning display is a display for warning or alerting a driver and passengers, for example a display for informing the driver and the passenger about ON/OFF state of a blinker etc., warning for half-shut door, and malfunction of an apparatus provided in a vehicle.

The liquid crystal display device of the present invention may be a vertical alignment mode liquid crystal display device.

The vertical alignment mode (MVA mode) liquid crystal display device allows a reduction in luminance of black display areas. Therefore, according to the above arrangement, the luminance of the black display area is reduced so that occurrence of black floating (a graying of black level) can be prevented. This allows a displayed image to have high contrast.

The liquid crystal display device of the present invention may be arranged such that a maximum gradation value, (the maximum gradation value−1), . . . (the maximum gradation value−n) (n is any integer in a range of 1 to 10) are used as gradation values exclusively used for the first image data, and the gradation conversion section further carries out gradation conversion processing with respect to each image data having a corresponding one of the gradation values exclusively used for the first image data so that a conversion to a gradation value which causes an arbitrary color to be displayed is carried out.

According to the arrangement, image data having at least one of the maximum gradation value, (the maximum gradation value−1), . . . (the maximum gradation value−n) is identified as the first image data, and the image data having such a gradation value exclusively used for the first image data is subjected to processing of uniformly converting gradation values into respective predetermined ones. This makes it possible to simultaneously carry out identification of the type of image data in the image data identification section and the conversion processing in the gradation conversion section. This allows the image data identification section and the gradation conversion section to be combined into a single calculator, thereby simplifying a circuit configuration.

The liquid crystal display device of the present invention may be arranged such that a minimum gradation value, (the minimum gradation value+1), . . . (the minimum gradation value+n) (n is any integer in a range of 1 to 10) are used as gradation values exclusively used for the first image data, and the gradation conversion section further carries out gradation conversion processing with respect to each image data having a corresponding one of the gradation values exclusively used for the first image data so that a conversion to a gradation value which causes an arbitrary color to be displayed is carried out.

According to the arrangement, image data having at least one of the minimum gradation value, (the minimum gradation value+1), . . . (the minimum gradation value+n) is identified as the first image data, and the image data having such a gradation value exclusively used for the first image data is subjected to processing of uniformly converting gradation values into respective predetermined ones. This makes it possible to simultaneously carry out identification of the type of image data in the image data identification section and the conversion processing in the gradation conversion section. This allows the image data identification section and the gradation conversion section to be combined into a single calculator, thereby simplifying a circuit configuration.

The liquid crystal display device of the present invention may be arranged such that in a case where (i) the maximum gradation value is used as the gradation value exclusively used for the first image data and (ii) the gradation conversion section does not carry out the gradation conversion processing for reducing the luminance of the displayed image, the gradation conversion section further carries out a conversion of gradation value with respect to the second image data so that luminance corresponding to (the maximum gradation value−1) becomes identical to that corresponding to the maximum gradation value.

The liquid crystal display device of the present invention may be arranged such that in a case where (i) the minimum gradation value is used as the gradation value exclusively used for the first image data and (ii) the gradation conversion section does not carry out the gradation conversion processing for reducing the luminance of the displayed image, the gradation conversion section further carries out a conversion of gradation value with respect to the second image data so that luminance corresponding to (the minimum gradation value+1) becomes identical to that corresponding to the minimum gradation value.

According to any one of the above arrangements, it is possible to prevent a situation in which, in a case where the gradation conversion section does not carry out the gradation conversion processing for reducing luminance of a displayed image (e.g. in the day mode), a range of luminance available for the second image data is narrowed since the maximum gradation value is not used in the second image data.

In each of the above arrangements, the arbitrary color is a noticeable color such as red, blue, orange, yellow, green, white, cyan, or magenta which are colors normally used for warning display, in a case where the first image data is the data for warning display.

Further, since n is any integer in a range of 1 to 10, it is possible to secure gradation expressing capability of the second image data in which the other gradation values are used. Further, since color of the warning display can be varied depending on a value of n, the value of n can be determined based on what kind of color the warning display has.

The liquid crystal display device of the present invention may be arranged so as to further includes: a backlight which irradiates the display panel with light; and a backlight driving circuit which controls luminance of the backlight.

According to the above arrangement, luminance of the backlight can be varied depending on an environmental change such as ambient brightness.

For example, in a liquid crystal display device which has two kinds of image display modes, i.e., a day mode and a night mode, the backlight driving circuit preferably controls luminance of the backlight so that luminance of the backlight in the night mode is lower than that in the day mode. This allows a further reduction in luminance of a low gradation area in the night mode.

An image processing method of the present invention is an image processing method for use in a liquid crystal display device which causes an image to be displayed on a display panel in response to an image signal including first image data for displaying information of high importance and second image data for displaying information other than the information of high importance, the first image data having a gradation value exclusively used for the first image data, said image processing method includes the steps of: (a) determining whether image data to be processed is the first image data or the second image data by judging whether or not the image data has the gradation value exclusively used for the first image data; and (b) carrying out gradation conversion processing with respect to the image data so that luminance of a displayed image is reduced in a case where ambient brightness declines, in the step (b), the gradation conversion processing is carried out with respect to image data, which has been determined to be the second image data in the step (a), so as to reduce the luminance of the image data.

According to the method, there is provided a gradation value exclusively used for the first image data so that it is possible to distinguish between the first image data and the second image data. Since (i) there is provided a gradation value exclusively used for the first image data and (ii) the gradation value exclusively used for the first image data is not used in the second image data, it is possible to easily distinguish between the first image data and the second image data.

This makes it possible to easily distinguish between the first image data and the second image data while the number of bits is limited to a predetermined one, without causing any increase in circuit size in spite of increasing the number of bits of the image data.

Further, in a case where ambient brightness declines (e.g. in the nighttime), the second image data is subjected to gradation conversion processing for reducing luminance of a displayed image. This allows luminance of a displayed image created based on the second image data to be changed in accordance with a change in ambient brightness. Meanwhile, since the first image data is not subjected to such gradation conversion processing for reducing luminance of a displayed image, luminance of information of high importance can be kept high.

Since it is possible to easily distinguish between the first image data and the second image data, only the second image data can be subjected to image processing, such as pseudo multi-gradation processing, which suppresses a decline in image quality.

In an on-vehicle liquid crystal display device, examples of the information of high importance includes warning information for notifying a driver, for example, about malfunction of an apparatus provided in a vehicle. In a case where image data for warning display is the first image data, it is possible to maintain high luminance as for an image displaying the warning information regardless of a change in ambient brightness.

The warning information is information for warning or alerting a driver and passengers, for example information for informing the driver and the passenger about ON/OFF state of a blinker etc., warning for half-shut door, and malfunction of an apparatus provided in a vehicle.

The image processing method of the present invention may be arranged so that the step (b) carries out processing which causes the gradation value of the image data to be shifted to a lower gradation value, said image processing method, further including the step of: (c) carrying out pseudo multi-gradation processing with respect to the second image data in a case where the gradation conversion processing is carried out, in the step (b), with respect to the second image data.

The processing which causes the gradation value of the image data to be shifted to a lower gradation value indicates processing in which (i) the maximum gradation value is shifted from 63 to 46 and (ii) the other gradation values are shifted to respective lower ones accordingly, in the case of 6-bit image data. As a result of reducing the maximum gradation value from 63 to 46, luminance of a displayed image declines by about 50%. Further, the number of available gradations is reduced from 64 (0 through 63) to 47 (0 through 46).

According to the method, the pseudo multi-gradation processing can suppress a decline in gradation expressing capability which decline is caused by a reduction in the number of gradations. This makes it possible to suppress a decline in image quality even in a case where the second image data is subjected to the gradation conversion processing for reducing luminance of a displayed image.

In the image processing method of the present invention, it is preferable that a maximum gradation value or a minimum gradation value is used as the gradation value exclusively used for the first image data.

According to the method, in which the maximum gradation value or the minimum gradation value is used as the gradation values exclusively used for the first image data, it is possible to efficiently carry out the gradation conversion processing with respect to the second image data in which gradation values other than the gradation value exclusively used for the first image data are used. Further, using the maximum gradation value in the first image data increases luminance of an image displayed based on the first image data, thereby making the image more noticeable than an image displayed based on the second image data.

The image processing method of the present invention may be arranged such that in the step (b), it is selected whether to carry out the gradation conversion processing depending on whether the liquid crystal display device is in a night mode or in a day mode, and the gradation conversion processing is carried out in the night mode.

According to the arrangement, an image displayed based on the second image data can have reduced luminance in the night mode. The night mode and the day mode are image display modes of the display panel. Switching between the night mode and the day mode is carried out in response to a display mode instruction signal generated, in the device, based on information concerning ambient brightness detected by an illuminance sensor provided in a vehicle or based on ON/OFF of a switch for a front position light or a headlamp, for example.

The image processing method of the present invention may be arranged such that a maximum gradation value, (the maximum gradation value−1), . . . (the maximum gradation value−n) (n is any integer in a range of 1 to 10) are used as gradation values exclusively used for the first image data, and in the step (b), gradation conversion processing is further carried out with respect to each image data having a corresponding one of the gradation values exclusively used for the first image data so that a conversion to a gradation value which causes an arbitrary color to be displayed is carried out.

According to the method, image data having at least one of the maximum gradation value, (the maximum gradation value−1), . . . (the maximum gradation value−n) is identified as the first image data, and the image data having such a gradation value exclusively used for the first image data is subjected to processing of uniformly converting gradation values into respective predetermined ones. This makes it possible to more easily identify a type of image data in the image data identification step (step (a)).

The image processing method of the present invention may be arranged such that a minimum gradation value, (the minimum gradation value+1), . . . (the minimum gradation value+n) (n is any integer in a range of 1 to 10) are used as the gradation value exclusively used for the first image data, and in the step (b), gradation conversion processing is further carried out with respect to each image data having a corresponding one of the gradation values exclusively used for the first image data so that a conversion to a gradation value which causes an arbitrary color to be displayed is carried out.

According to the method, image data having at least one of the minimum gradation value, (the minimum gradation value+1), . . . (the minimum gradation value+n) is identified as the first image data, and the image data having such a gradation value exclusively used for the first image data is subjected to processing of uniformly converting gradation values into respective predetermined ones. This makes it possible to more easily identify a type of image data in the image data identification step (step (a)).

In each of the methods, the arbitrary color is a noticeable color such as red, blue, orange, yellow, green, white, cyan, or magenta which are colors normally used for warning display, in a case where the first image data is the data for warning display.

Further, since n is any integer in a range of 1 to 10, it is possible to secure gradation expressing capability of the second image data in which the other gradation values are used. Further, since color of the warning display can be varied depending on a value of n, the value of n can be determined based on what kind of color the warning display has.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a control block diagram showing an arrangement of a liquid crystal display device of an embodiment of the present invention.

FIG. 2 is a view schematically showing a flow of image data processing carried out in a day mode by the liquid crystal display device shown in FIG. 1. A right portion of FIG. 2 schematically shows gradations to be displayed on a liquid crystal display.

FIG. 3 is a view schematically showing a flow of image data processing carried out in a night mode by the liquid crystal display device shown in FIG. 1. A right portion of FIG. 2 schematically shows gradations to be displayed on a liquid crystal display.

FIG. 4 is a view schematically showing an exemplary data structure of image data in a image processing method of the present invention.

FIG. 5 is a view schematically showing an example in which the image data shown in FIG. 4 is subjected to gradation conversion processing.

FIG. 6 is a block diagram showing an arrangement of a liquid crystal display device of a modification of Embodiment 1 of the present invention.

FIG. 7 is a view schematically showing an example of a flow of image data processing carried out in a day mode by a liquid crystal display device of Embodiment 2 of the present invention. A right portion of FIG. 7 schematically shows gradations to be displayed on a liquid crystal display.

FIG. 8 is a view schematically showing an example of a flow of image data processing carried out in a night mode by a liquid crystal display device of Embodiment 2 of the present invention. A right portion of FIG. 8 schematically shows gradations to be displayed on a liquid crystal display.

FIG. 9 is a control block diagram showing an arrangement of a liquid crystal display device of Embodiment 3 of the present invention.

FIG. 10 is a control block diagram showing an arrangement of a liquid crystal display device of Embodiment 4 of the present invention.

FIG. 11 showing a result of measuring luminance of conventional liquid crystal display devices and luminance of liquid crystal display devices of the present invention.

FIG. 12 is a control block diagram showing a first example of a conventional in-vehicle liquid crystal display device.

FIG. 13 is a view schematically showing a flow of image data processing carried out in a day mode by the liquid crystal display device shown in FIG. 12. A right portion of FIG. 13 schematically shows gradations to be displayed on a liquid crystal display.

FIG. 14 is a view schematically showing a flow of image data processing carried out in a night mode by the liquid crystal display device shown in FIG. 12. A right portion of FIG. 14 schematically shows gradations to be displayed on a liquid crystal display.

FIG. 15 is a control block diagram showing a second example of an arrangement of a conventional in-vehicle liquid crystal display device.

FIG. 16 is a view schematically showing a flow of image data processing carried out in a day mode by the liquid crystal display device shown in FIG. 15. A right portion of FIG. 16 schematically shows gradations to be displayed on a liquid crystal display.

FIG. 17 is a view schematically showing a flow of image data processing carried out in a night mode by the liquid crystal display device shown in FIG. 15. A right portion of FIG. 17 schematically shows gradations to be displayed on a liquid crystal display.

### REFERENCE SIGNS LIST

10: Liquid crystal display device
10a: Liquid crystal display device
11: Liquid crystal display
12: Backlight
13: Gate driver
14: Source driver
15: Backlight driving circuit
16: Display controller
17: Instrument panel control system
18: Operating switch
21: Gradation conversion section
22: Gradation calculator (gradation conversion section, image data identification section)
23: Pseudo multi-gradation processing section
24: Liquid crystal controller
25: ROM
26: Image data identification section
42: Gradation calculator
50: Liquid crystal display device
60: Liquid crystal display device

### DESCRIPTION OF EMBODIMENTS

### Embodiment 1

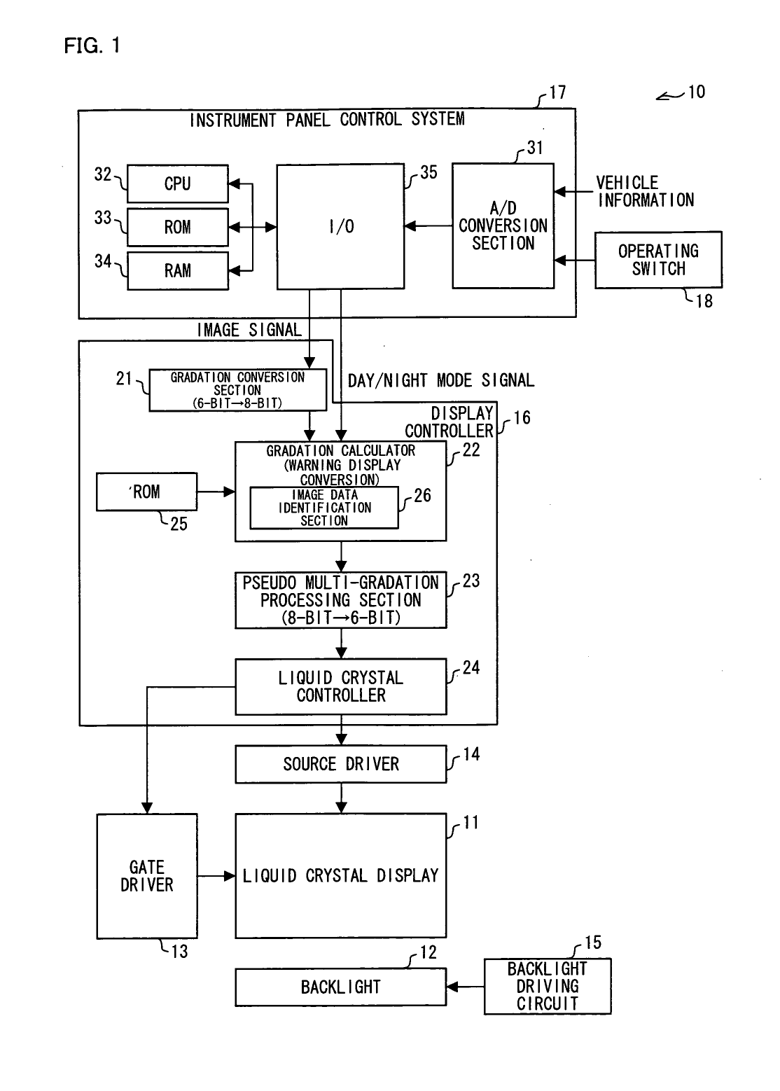

An embodiment of the present invention is described below with reference to FIGS. 1 through 5. Note that the present invention is not limited to this. The present embodiment deals with, as an example, an in-vehicle liquid crystal display device. The in-vehicle liquid crystal display device is a device which is provided in a vehicle and which displays information supplied from various sensors and in-vehicle apparatuses. The in-vehicle liquid crystal display device can be also used as a car navigation system or a television, for example. FIG. 1 shows an arrangement of a liquid crystal display device 10 of the present embodiment. The liquid crystal display device 10 has a function of adjusting brightness of an image displayed on a liquid crystal display screen in accordance with a change in ambient brightness (e.g., because ambient brightness differs in the daytime and in the nighttime).

As shown in FIG. 1, the liquid crystal display device 10 mainly includes a liquid crystal display 11 (display panel), a backlight 12, a gate driver 13, a source driver 14, a backlight driving circuit 15, a display controller 16, an instrument panel control system 17, and an operating switch 18.

The liquid crystal display 11 includes an active matrix substrate, and a counter substrate, and a liquid crystal layer provided between the active matrix substrate and the counter substrate. In the present embodiment, an MVA mode, a TN mode, an IPS mode, or the like can be employed as a display mode of the liquid crystal display.

The backlight 12 is provided behind the liquid crystal display 11, and irradiates the liquid crystal display 11 with light. The backlight driving circuit 15 controls at least ON/OFF and luminance of the backlight 12.

The display controller 16 generates, in response to an image data signal supplied from the instrument panel control system 17, a driving signal for causing the liquid crystal display 11 to display an image. The display controller 16 includes a gradation conversion section 21, a gradation calculator 22 (image data identification section, gradation conversion section), a pseudo multi-gradation processing section 23, a liquid crystal controller 24, and a ROM 25.

The display controller 16 carries out gradation conversion processing with respect to image data (image signal) supplied from the instrument panel control system 17 so that luminance of a displayed image is reduced in a case where ambient brightness declines. The gradation conversion processing is carried out only with respect to data (second image data) for display (herein referred to as “general display”) other than warning display, and is therefore not carried out with respect to image data (image data for waning display, first image data) for displaying warning information such as an ON/OFF state of a blinker etc., warning for a half-shut state, malfunction of equipments provided in a vehicle. A flow of the processing carried out in the display controller 16 is described later in detail.

The instrument panel control system 17 generates an image data signal for causing the liquid crystal display 11 to display an image, based on information supplied from various sensors, a position detector, and other apparatuses provided in a vehicle (hereinafter collectively referred to as “vehicle information”) or based on information entered by use of the operating switch 18.

The instrument panel control system 17 includes an A/D conversion section 31, a CPU 32, a ROM 33, a RAM 34, and a data input/output section (I/O) 35.

The A/D conversion section 31 converts inputted analog data (e.g. data of vehicle information or data entered via the operating switch) into digital data, and supplies the digital data to the I/O 35.

The I/O 35 receives data externally supplied via the A/D conversion section 31, and supplies the data to the CPU 32, which serves as a data processing section in the instrument panel control system 17, and to various memories (ROM 33 and RAM 34). The data processed in the CPU 32 is supplied outside, i.e., to the display controller 16, via the I/O 35. The data processed in the CPU 32 is temporarily stored in the memories, and is then supplied outside, i.e., to the display controller 16, via the I/O 35 at an appropriate timing.

The liquid crystal display device 10 of the present embodiment has a function of adjusting, in accordance with a change in ambient brightness, brightness of an image displayed on the liquid crystal display. In order to realize this, the instrument panel control system 17 generates a signal (a day/night mode signal), instructing switching of an image display mode, based on information concerning ambient brightness detected by an illuminance sensor provided in the vehicle.

Specifically, the information concerning ambient brightness detected by the illuminance sensor provided in the vehicle is supplied, as vehicle information, to the instrument panel control system 17. Then, the CPU 32 in the instrument panel control system 17 determines, based on the vehicle information thus supplied, whether or not the ambient brightness is not more than a predetermined value. In a case where it is determined that the ambient brightness exceeds the predetermined value, a signal (day/night mode signal) instructing a day mode is generated. In contrast, in a case where it is determined that the ambient brightness is not more than the predetermined value, a signal (day/night mode signal) instructing a night mode is generated. The day/night mode signal is supplied to the display controller 16 via the I/O 35, as with the image data.

Switching of the day/night mode signal between the night mode and the day mode can be automatically carried out based on a result detected by the illuminance sensor as above. Note, however, that such switching can be carried out based on ON/OFF of a switch for a front position light or a headlamp (headlight) (for example, the image display mode is changed to the night mode while the switch is being turned ON, whereas the image display mode is changed to the day mode while the switch is being turned OFF).

Based on the image data and the day/night mode signal supplied from the instrument panel control system 17, the display controller 16 carries out gradation conversion processing, which varies depending on a change in ambient brightness, with respect to specific image data (second image data (e.g. data for general display)), and further carries out pseudo multi-gradation processing with respect to the image data that has been subjected to the gradation conversion processing.

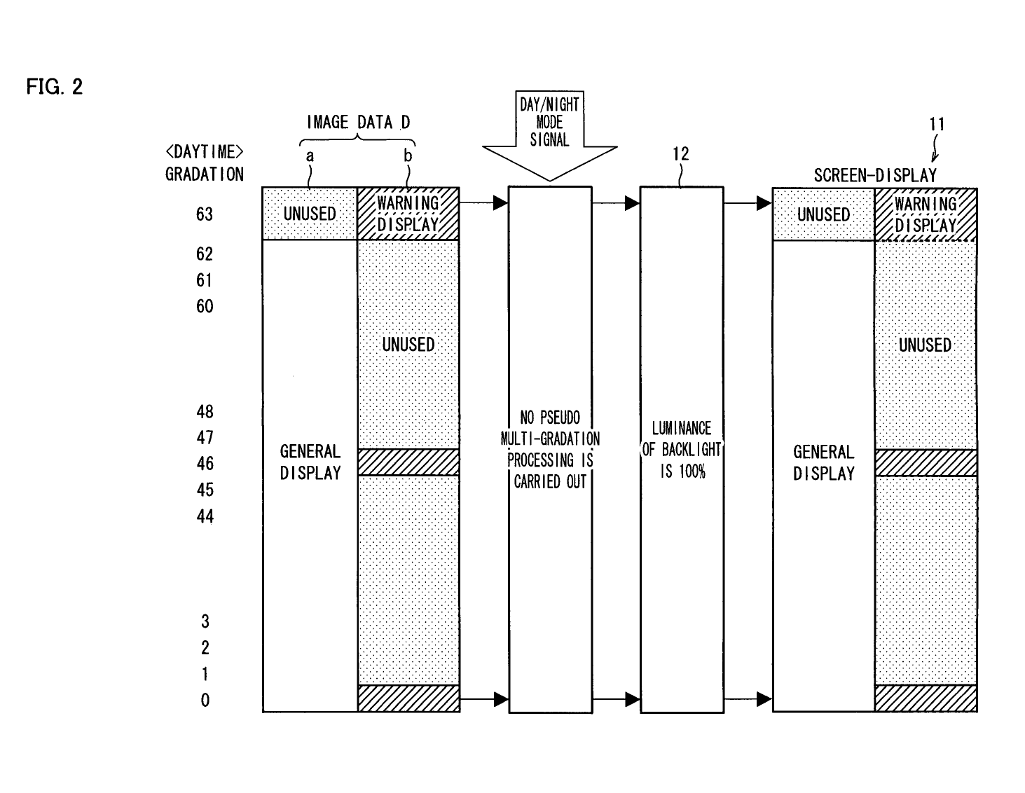

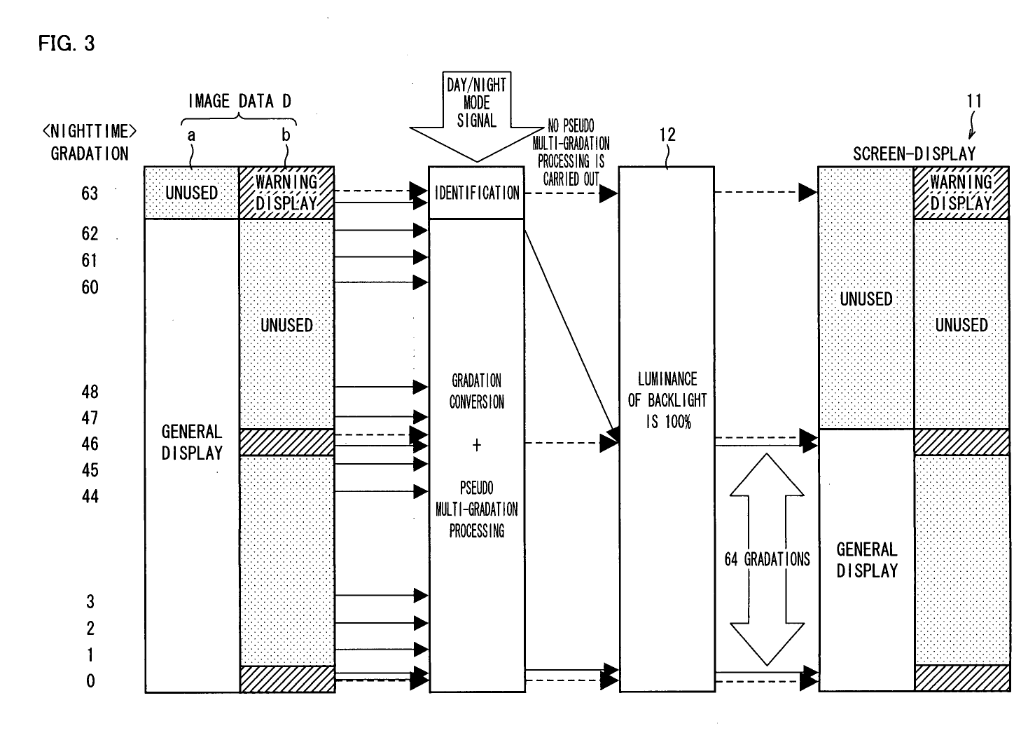

The following description deals with a flow of the gradation conversion processing which is carried out in the present embodiment, with reference to FIGS. 1 through 3. FIG. 2 shows a flow of image data processing which is carried out in the day mode by the liquid crystal display device 10 shown in FIG. 1. FIG. 3 shows a flow of image data processing which is carried out in the night mode by the liquid crystal display device 10 shown in FIG. 1.

The present embodiment deals with an example in which 6-bit image data is displayed with the use of a 6-bit driver. Note, however, that the present invention is not limited to this, and is therefore applicable to a case where 4-bit image data is displayed with the use of a 4-bit driver, a case where 8-bit image data is displayed with the use of a 8-bit driver, and a case where 10-bit image data is displayed with the use of a 10-bit driver.

Normally, the warning display is red, blue or orange in color. In a case where the warning display is red in 6-bit image data, a combination of gradation values of red (R), green (G), and blue (B) pixels which constitute one (1) pixel is (63, 0, 0). In a case where the warning display is blue in 6-bit image data, a combination of the gradation values of the red (R), green (G), and blue (B) pixels is (0, 0, 63). In a case where the warning is orange in 6-bit image data, a combination of the gradation values of the red (R), green (G), and blue (B) pixels is (63, 46, 0). That is, only gradation values 0, 46, and 63 are used in image data b for warning display, and the other gradation values are therefore not used in the image data b for warning display (see FIGS. 2 and 3). Note that the above combination of the gradation values for expressing orange is merely an example and the present embodiment is therefore not limited to this.

Left parts of FIGS. 2 and 3 each show a data structure of image data (image signal) D supplied from the instrument panel control system 17. The image data D includes image data a (second image data) for general display and the image data b (first image data) for warning display. As for the image data a for general display out of the image data D supplied from the instrument panel 17 to the display controller 16, the gradation values 0 through 62 are used, and the maximum gradation value 63 is therefore not used (see FIGS. 2 and 3). Meanwhile, as for the image data b for warning display, only the gradation values 0, 46, and 63 are used, and the other gradation values are therefore not used, as described above.

The maximum gradation value 63 is thus not used in the image data a for general display, and is used only in the image data b for warning display. In other words, the gradation value 63 is an exclusive gradation value for data for warning display. This means that it is possible to determine whether data in the image data D is the image data a for general display or the image data b for warning display, by determining whether or not the data has the maximum gradation value 63.

The gradation calculator 22 in the display controller 16 includes an image data identification section 26 which identifies a type of image data. The image data identification section 26 distinguishes, based on the image data D, between the image data a for general display and the image data b for warning display (image data identification step).

The gradation conversion section 21 carries out conversion processing, with respect to the image data D supplied from the instrument panel control system 17 to the display controller 16, so that 6-bit image data is converted into 8-bit image data in preparation for pseudo multi-gradation processing that is carried out later.

The image data D that has been converted into the 8-bit data by the gradation conversion section 21 is supplied to the gradation calculator 22 (gradation conversion section). The gradation calculator 22 causes the image data identification section 26 to distinguish, based on the image data D, between the image data a for general display and the image data b for warning display. The gradation calculator 22 determines, based on the day/night mode signal supplied from the instrument panel control system 17, whether to carry out the gradation conversion processing for reducing luminance of a displayed image.

In a case where the day/night mode signal instructs the day mode, the gradation conversion processing and the pseudo multi-gradation processing are not carried out with respect to the image data D (see FIG. 2). In this case, the gradation calculating section 22 and the pseudo multi-gradation processing section 23 do not carry out processing for changing the gradation values. The pseudo multi-gradation processing section 23 merely carries out processing in which the 8-bit image data is converted into 6-bit image data again, and the image data is then supplied to the liquid crystal controller 24. Further, the backlight 12 irradiates the liquid crystal display 11 with light at the rated power (100 percent power). This is because the liquid crystal display device 10 is not configured to adjust luminance of the backlight 12 in accordance with ambient brightness. This causes screen-display to be carried out by use of the gradation values 0 through 63 in both of the general display and the warning display in the day mode (see FIG. 2).

Meanwhile, in a case where the day/night mode signal instructs the night mode, the gradation calculator 22 carries out gradation value conversion processing in which gradation values of image data are converted into lower ones so that luminance of a displayed image is reduced. Note that the gradation calculating section 22 carries out the gradation value conversion processing only with respect to image data which has been identified as the image data a for general display by the image data identification section 26 (gradation conversion step).

In a case where it is dark outside the vehicle (e.g. in the nighttime), the gradation calculator 22 thus carries out gradation conversion processing with respect to the image data a for general display so that (i) higher gradation values are not used in the image data a for general display, and (ii) only gradation values ranging from lower to intermediate gradation values are used in the image data a for general display. It is thus possible to carry out the processing, only with respect to the image data a for general display, in which the brightness of a displayed image is changed in accordance with ambient brightness.

More specifically, in a case where the day/night mode signal instructs the night mode, the image data b for general display is subjected to the gradation conversion processing in which gradation values of image data are converted into lower ones. In the present embodiment, “the processing in which the gradation values of image data are converted into lower ones” indicates processing in which (i) the maximum gradation value is shifted from 63 to 46 and (ii) the other gradation values are shifted to respective lower ones accordingly, in the case of 6-bit image data. Such gradation conversion processing can be carried out, for example, with the use of a conversion table stored in the ROM 25.

The image data b for general display that has been subjected to the gradation value conversion processing in the gradation calculator 22 is subsequently subjected to pseudo multi-gradation processing in the pseudo multi-gradation processing section 23 (pseudo multi-gradation processing step).

The pseudo multi-gradation processing section 23 carries out pseudo multi-gradation processing by use of a known multi-gradation technique so that a reduction in the number of gradations (so-called tone jump) is not caused by the gradation conversion of the gradation calculating section 22.

The pseudo multi-gradation processing is processing which causes a human eye to believe that the number of gradations that can be expressed increased although the number of gradations that can be expressed is limited in fact. This utilizes nature of the human eye (i.e., the human eye perceives, as luminance, time- and space-averaged luminance). The pseudo multi-gradation processing is classified into various types (e.g. FRC) depending on a size of a pixel region which serves as a unit or design of a noise pattern (i.e., noise pattern in each frame, the number of periodic frames etc.).

For example, Patent Literature 2 discloses a specific method of the pseudo multi-gradation processing. Such a method is applicable to the present invention.

In the present embodiment, 6-bit image data is converted into 8-bit image data by the gradation conversion section 21 in preparation for the pseudo multi-gradation processing. Then, the pseudo multi-gradation processing section 23 divides the 8-bit image data into higher 6 bits and lower 2 bits with the use of a 6-bit driver, prepares a 1-bit noise pattern based on information of the lower 2 bits, and then causes the 1-bit noise pattern to be superimposed on each pixel (the higher 6 bits+1-bit noise pattern). This causes the 8-bit image data to be converted into 6-bit image data again.

Note that the image data b for warning display is not subjected to the gradation conversion processing. This causes the maximum gradation value 63 to be used in the image data b for warning display, similar to the day mode. Specifically, in a case of red warning display, a combination of gradation values of a pixel constituting the image data b is (R=63, G=0, B=0). In a case of blue warning display, a combination of gradation values of a pixel constituting the image data b is (R=0, G=0, B=63). In a case of orange warning display, a combination of gradation values of a pixel constituting the image data b is (R=63, G=46, B=0).

The image data D that has been subjected to the processing as above is supplied to the liquid crystal controller 24. The liquid crystal controller 24 generates a driving signal for causing the liquid crystal display 11 to display an image based on the image data D thus supplied, and then supplies the driving signal to the gate driver 13 and the source driver 14. The liquid crystal display 11 displays an image in response to various signals such as a scanning signal and a data signal which are supplied from the gate driver 13 and the source driver 14, respectively.

As a result, the warning display is carried out by use of the gradation values 0 through 63 in the night mode. Meanwhile, the general display is carried out by use of gradation values 0 through 46 while the pseudo multi-gradation processing is securing expressive power of 64 gradations (see FIG. 3). Note that the backlight 12 irradiates the liquid crystal display 11 with light at the rated power (100 percent power). This is because the liquid crystal display device 10 is not configured to adjust luminance of the backlight 12 in accordance with ambient brightness.

The above embodiment has discussed an example in which, in the day mode, the image data D is not subjected to the gradation conversion processing and the pseudo multi-gradation processing each for adjusting luminance. However, the present invention is not limited to this. In a case where a driver can optionally adjust luminance in accordance with ambient brightness even in the daytime, (i) gradation conversion processing is carried out so that gradation values of image data are converted and (ii) pseudo multi-gradation processing is carried out so that a reduction in the number of gradations which reduction is caused by the gradation conversion processing is compensated.

### Conventional Example 1

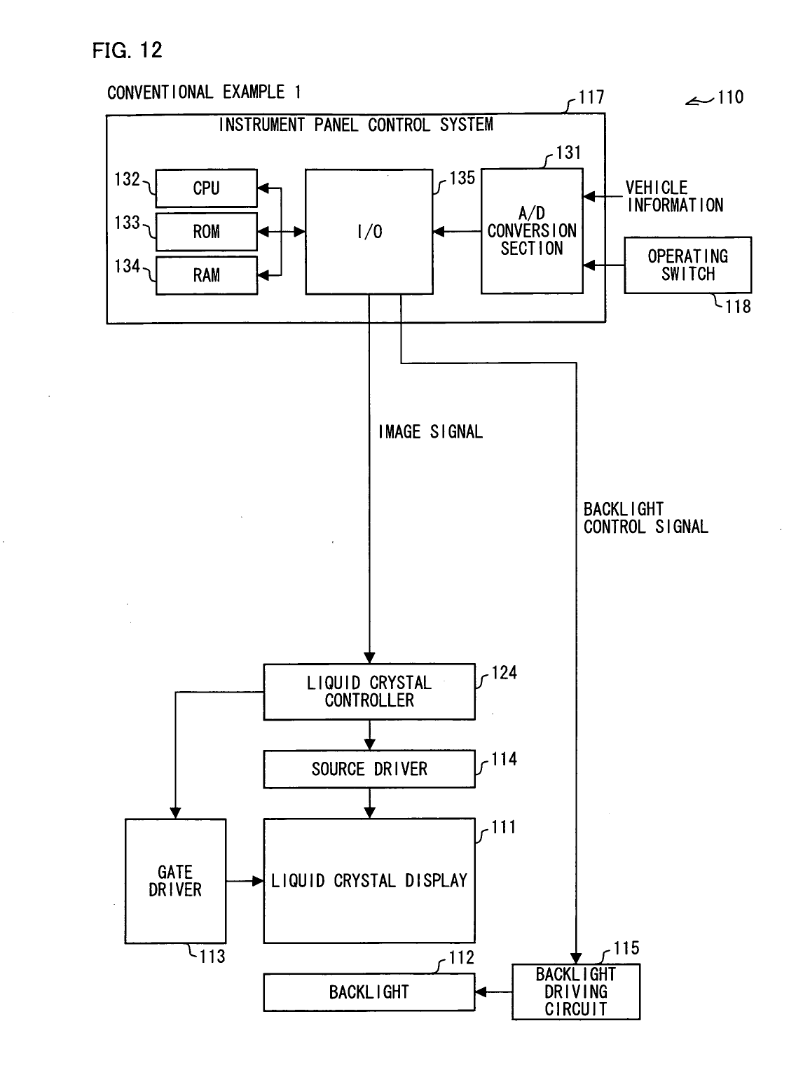

With reference to FIGS. 12 through 14, the following description deals with, as a comparative example of the present invention, an arrangement of a conventional in-vehicle liquid crystal display device 110 (conventional example 1) and a method for adjusting brightness of a displayed image in the liquid crystal display device 110. Note that the following description deals with an example in which 6-bit image data is displayed with the use of a 6-bit driver.

FIG. 12 shows the arrangement of the liquid crystal display device 110. As shown in FIG. 12, the liquid crystal display device 110 mainly includes a liquid crystal display 111, a backlight 112, a gate driver 113, a source driver 114, a backlight driving circuit 115, a liquid crystal controller 124, an instrument panel control system 117, and an operating switch 118.

The instrument panel control system 117 includes an A/D conversion section 131, a CPU 132, a ROM 133, a RAM 134, and a data input/output section (I/O) 135.

As is clear from a comparison between the arrangement of FIG. 1 and the arrangement of FIG. 12, the conventional example 1 includes no display controller which carries out gradation conversion processing with respect to image data in accordance with ambient brightness. In the conventional example 1, brightness of a displayed image is not adjusted by carrying out gradation conversion processing but is adjusted by changing luminance of the backlight 112.

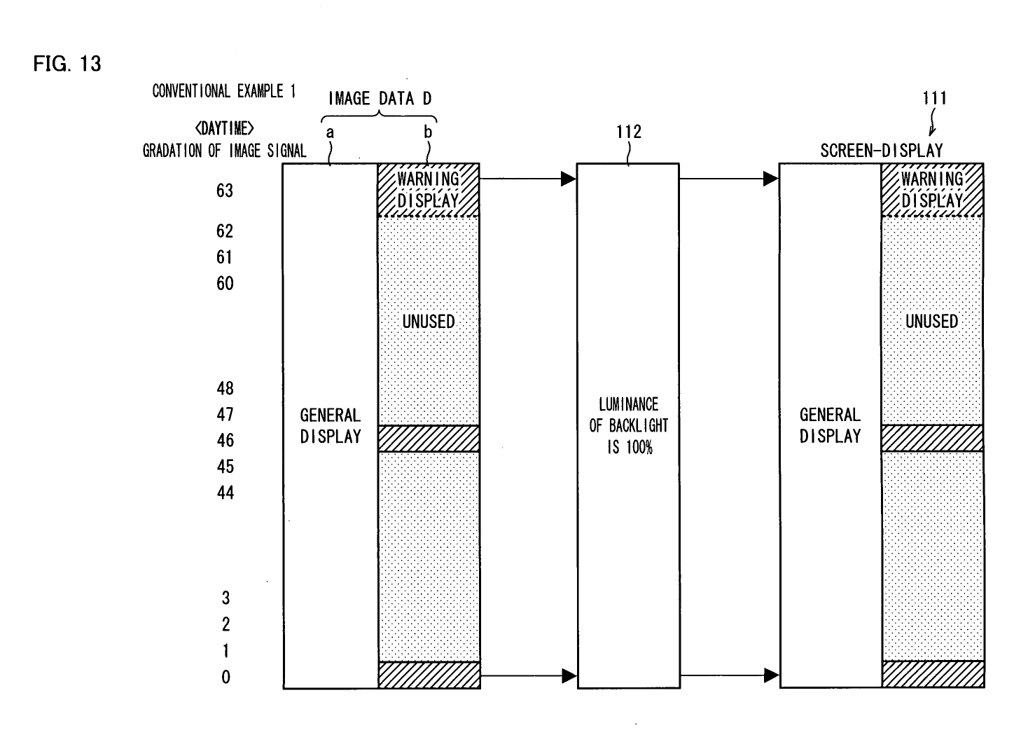

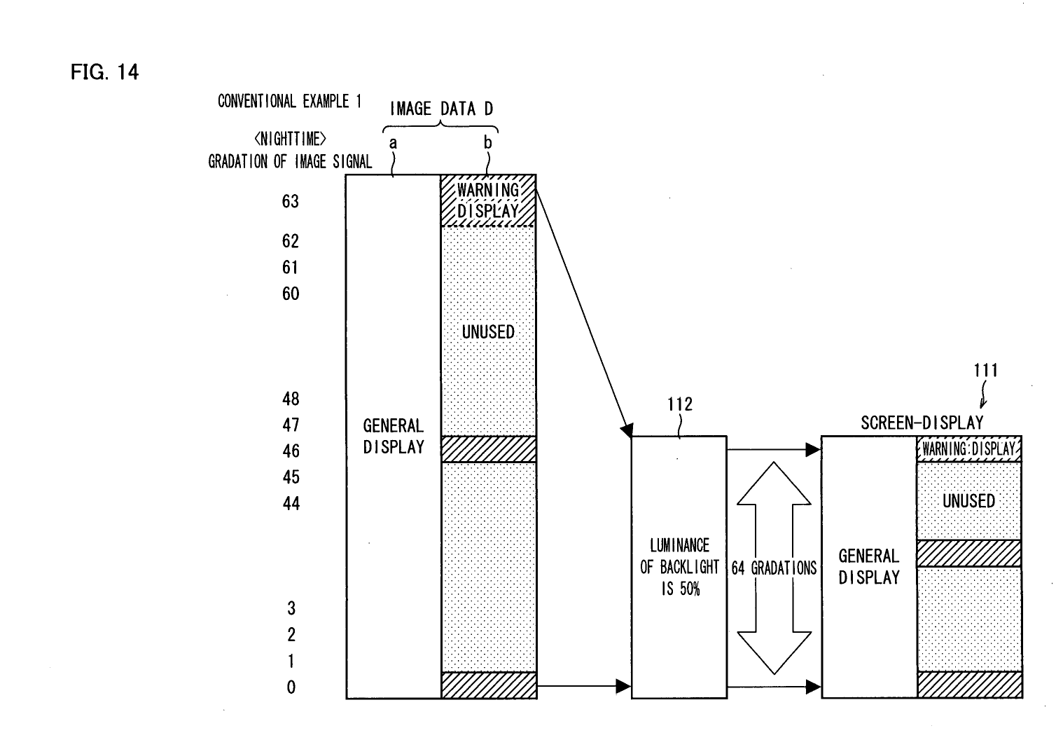

The following description deals with how luminance of the backlight 112 is changed in the daytime and in the nighttime. FIG. 13 shows a flow of image data processing which is carried out in a day mode by the liquid crystal display device 110 shown in FIG. 12. FIG. 14 shows a flow of image data processing which is carried out in a night mode by the liquid crystal display device 110 shown in FIG. 12.

Left parts of FIGS. 13 and 14 each show a data structure of image data (image signal) D supplied from the instrument panel control system 117. The image data D includes image data a for general display and image data b for warning display.

The luminance of the backlight 112 of the liquid crystal display device 110 is controlled in the daytime and in the nighttime as follows.

The instrument panel control system 117 receives, as vehicle information, information concerning ambient brightness detected by an illuminance sensor which is provided in a vehicle. Then, the CPU 132 of the instrument panel control system 117 determines, based on the vehicle information, whether or not the ambient brightness is not more than a predetermined value. In a case where it is determined that the ambient brightness exceeds the predetermined value, a signal (backlight control signal) which instructs the day mode is generated. In contrast, in a case where it is determined that the ambient brightness is not more than the predetermined value, a signal (backlight control signal) instructing the night mode is generated. The backlight control signal is supplied to the backlight driving circuit 115 via the I/O 135.

Switching of the backlight control signal between the night mode and the day mode can be automatically carried out based on a result detected by the illuminance sensor as described above. Note, however, that such switching can be carried out based on ON/OFF of a switch for a front position light or a headlamp (headlight) (for example, the image display mode is changed from the day mode to the night mode while the switch is being turned ON, whereas the image display mode is changed from the night mode to the day mode while the switch is being turned OFF).

In a case where the luminance of the backlight 112 is controlled in response to the backlight control signal, an image in the day mode and an image in the night mode are displayed as follows.

In the day mode (in a case where the backlight control signal instructs the day mode), the backlight irradiates the liquid crystal display 111 with light at its full power (see FIG. 13). This means that each of the general display and the warning display has maximum luminance in a case where a gradation value is 63 (see a right part of FIG. 13).

Meanwhile, in the night mode (in a case where the backlight control signal instructs the night mode), the luminance of the backlight is reduced to 50% (see FIG. 14). Namely, the brightness of the screen in the night mode is about one-half of that in the day mode, even if image display is carried out with use of 64-gradation which is used in the daytime (see right portion of FIG. 14).

According to the conventional example 1, brightness of an entire screen is adjusted by changing luminance of the backlight in accordance with ambient brightness. However, in a case where the brightness of the screen is adjusted in this manner, luminance of the entire screen is uniformly changed. Accordingly, in a case where the entire display screen is darkened for example in the nighttime, the warning display is also darkened. This causes a problem that it is difficult for a driver to appropriately recognize the warning display.

### Conventional Example 2

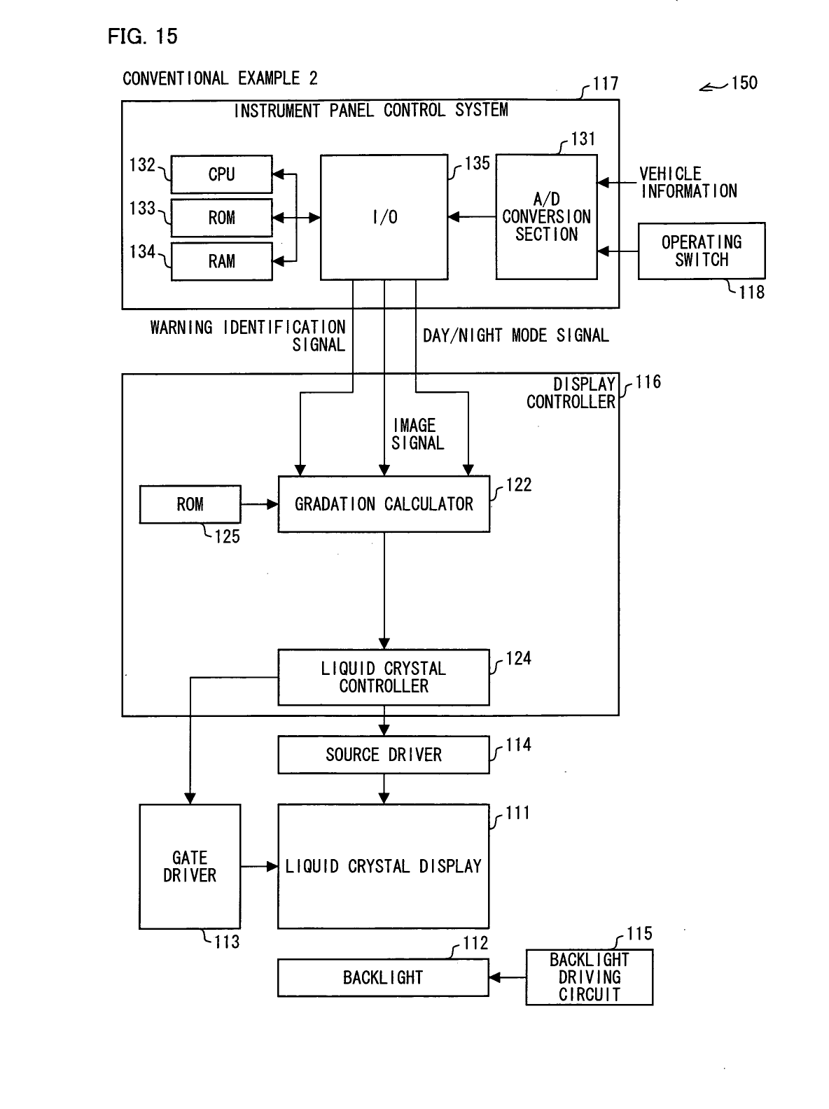

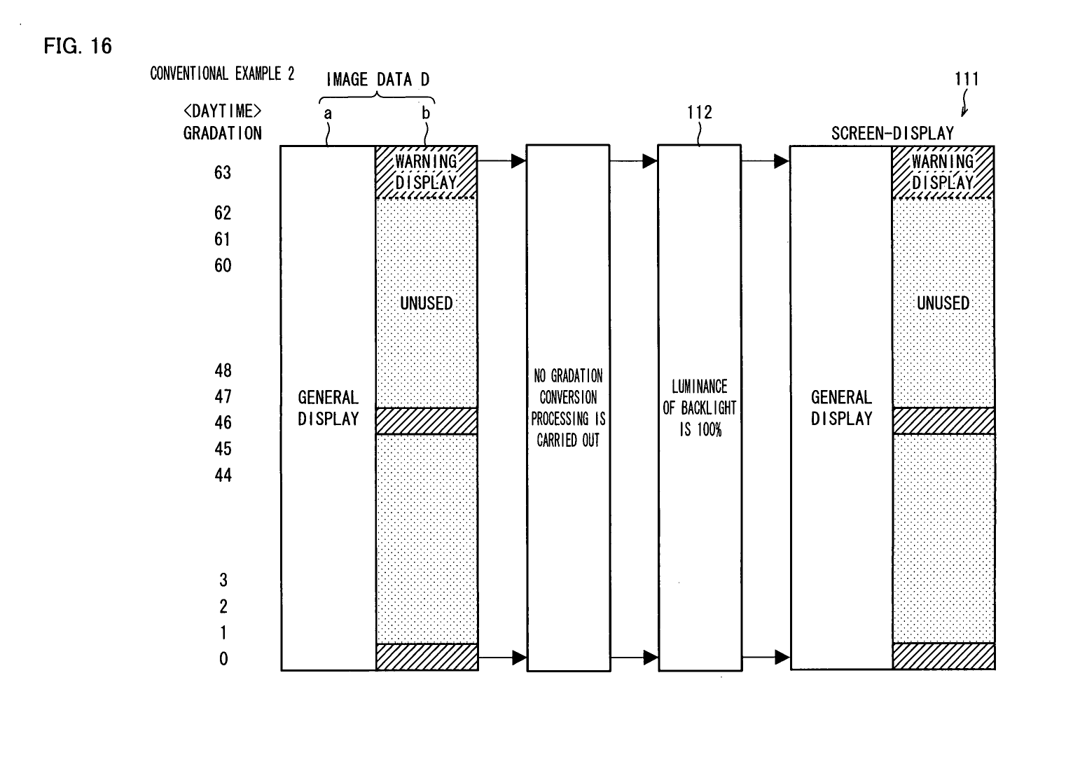

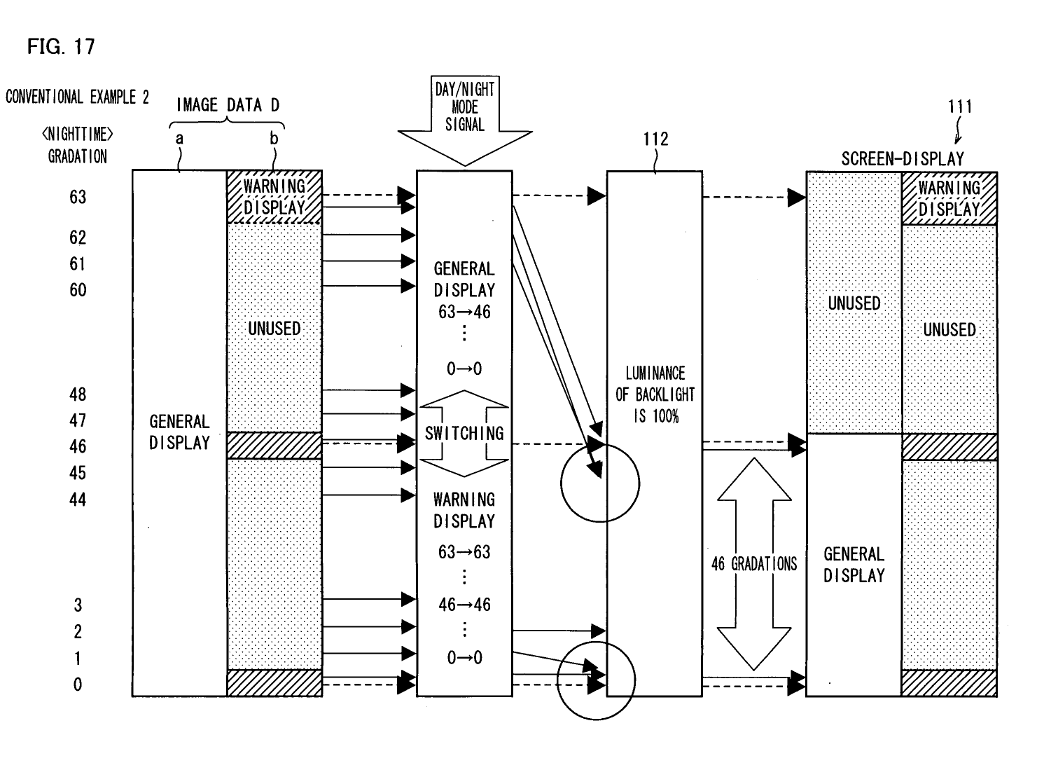

In order to solve the above problem, the following arrangement has been devised. This will be described below as a conventional example 2. The conventional example 2 is based on the technique disclosed in Patent Literature 1. FIG. 15 shows an arrangement of an in-vehicle liquid crystal display device 150 in accordance with the conventional example 2. FIG. 16 shows a flow of image data processing which is carried out in a day mode by the liquid crystal display device 150 shown in FIG. 15. FIG. 17 shows a flow of image data processing which is carried out in a night mode by the liquid crystal display device 150 shown in FIG. 15.

As shown in FIG. 15, the liquid crystal display device 150 mainly includes a liquid crystal display 111, a backlight 112, a gate driver 113, a source driver 114, a backlight driving circuit 115, a display controller 116, an instrument panel control system 117, and an operating switch 118.

The instrument panel control system 117 includes an A/D conversion section 131, a CPU 132, a ROM 133, a RAM 134, and a data input/output section (I/O) 135.

The display controller 116 includes a gradation calculator 122, a ROM 125, and a liquid crystal controller 124. Note that each of the gradation calculator 122 and the ROM 125 is not provided in the conventional example 1.

In a case where it is dark outside the vehicle (e.g. in the nighttime), the gradation calculator 122 carries out gradation conversion processing with respect to image data for general display so that (i) higher gradation values are not used in the image data for general display, and (ii) only gradation values ranging from lower to intermediate gradation values are used in the image data for general display. It is therefore possible to carry out the processing, with respect to the image data for general display, in which the brightness of a displayed image is changed in accordance with ambient brightness.

The following description deals with how the number of gradations for the general display only is varied between the daytime and the nighttime in the conventional example 2.

The instrument panel control system 117 receives, as vehicle information, information concerning ambient brightness detected by an illuminance sensor provided in a vehicle. Then, the CPU 132 of the instrument panel control system 117 determines, based on the vehicle information, whether or not the ambient brightness is not more than a predetermined value. In a case where it is determined that the ambient brightness exceeds the predetermined value, a signal (day/night mode signal) instructing the day mode is generated. In contrast, in a case where it is determined that the ambient brightness is not more than the predetermined value, a signal (day/night mode signal) instructing the night mode is generated. The day/night mode signal is supplied to the display controller 116 via the I/O 135.

Switching of the day/night mode signal between the night mode and the day mode by use can be automatically carried out based on a result detected by the illuminance sensor as described above. Note, however, that such switching can be carried out based on ON/OFF of a switch for a front position light or a headlamp (headlight) (for example, the image display mode is changed from the day mode to the night mode while the switch is being turned ON, whereas the image display mode is changed from the night mode to the day mode while the switch is being turned OFF).

The CPU 132 of the instrument panel control system 117 identifies types of various display information to be inputted. Specifically, the CPU 132 generates a warning identification signal for determining whether or not inputted data is data (image data for warning display) for displaying warning information such as ON/OFF state of a blinker etc., warning for half-shut door, and malfunction of equipments provided in a vehicle. The warning identification signal is supplied to the display controller 116 via the I/O 135.

In a case where the day/night mode signal supplied from the instrument panel control system 117 instructs the day mode, the gradation calculator 122 of the display controller 116 does not carry out gradation value conversion processing. Therefore, gradation values 0 through 63 are used for both of the general display and the warning display (see FIG. 16).

Meanwhile, in a case where the day/night mode signal supplied from the instrument panel control system 117 instructs the night mode, the gradation calculator 122 carries out, based on the warning identification signal, gradation value conversion processing with respect to image data (i.e. image data for general display) other than the image data for warning display (see FIG. 17). The gradation value conversion processing is carried out, for example, with the use of a conversion table stored in the ROM 125 so that the maximum gradation value is shifted from 63 to 46. Note that the gradation conversion processing is not carried out with respect to the image data for warning display, and therefore the maximum gradation value for the warning display is 63 in the night mode as well as in the day mode (see FIG. 17).

As described above, according to the conventional example 2, brightness of a display screen is changed depending on whether it is in the daytime or in the nighttime, not by changing luminance of the backlight but by changing gradation values to be used. Whether or not the gradation conversion processing is carried out can be selected depending on the type of information to be displayed. As such, it is possible to carry out the warning display even in the nighttime without a reduction in luminance.

However, according to the conventional example 2, the maximum gradation value is reduced from 63 to 46 so that the brightness is adjusted. Accordingly, the number of gradations is reduced from 64 to 47. This undesirably causes some of the gradations to overlap each other, i.e., causes a reduction in the number of gradations (so-called tone jump) (see the circled portion of FIG. 17).

A method such as the pseudo multi-gradation processing may be cited as the technique for suppressing such a reduction in the number of gradations. Note, however, that simply applying the pseudo multi-gradation processing will cause a problem that data for warning display is also unnecessarily subjected to the pseudo multi-gradation processing. In order to carry out the pseudo multi-gradation processing only with respect to data for general display, it is necessary to separately provide an arrangement for distinguishing, on a video memory, between the data for warning display and the data for general display. However, this undesirably causes a circuit configuration to be complicated.

### Advantages of Arrangement of Present Embodiment

In contrast, according to the arrangement of the present embodiment, there is provided a gradation value (e.g. the maximum gradation value is 63 in case of 6-bit data) which is exclusively used for image data for warning display so that it is possible to distinguish between the image data for warning display and the image data for general display. Since the image data for general display does not use such a gradation value exclusively used for the image data for warning display, it is possible to easily distinguish between the image data for warning display and the image data for general display. Further, in a case where, for example, the maximum gradation value is used as the gradation value exclusively used for the image data for warning display, it is possible to easily carry out gradation conversion processing with respect to the image data for general display.

This makes it possible to easily distinguish between the first image data and the second image data while the number of bits is limited to a predetermined one, without causing any increase in circuit size in spite of increasing the number of bits of the image data.

In a case where it is dark outside the vehicle (e.g., in the nighttime), only the image data for general display is subjected to gradation value conversion processing so that gradation values of the image data for general display are shifted to respective lower gradation values. This allows brightness of the general display to be changed in accordance with the ambient brightness, and allows high luminance of specific information such as warning display to be maintained.

Since it is possible to easily distinguish between the image data for warning display and the image data for general display, it is possible to cause only the image data for general display to be subjected to image processing for suppressing a deterioration in image quality. Since it is possible to cause only the image data for general display to be subjected, for example, to pseudo multi-gradation processing, it is possible to suppress a reduction in gradation expression capability due to nonuse of higher gradation values.

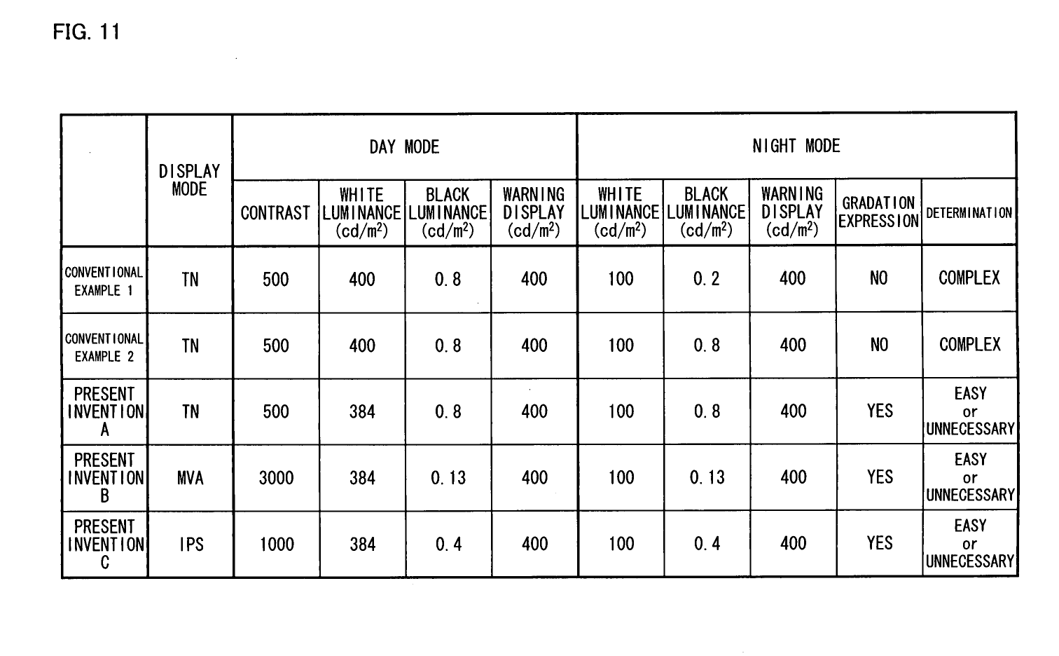

In (i) the arrangement of the present embodiment and (ii) the conventional examples 1 and 2, white luminance of the general display, black luminance of the general display, and luminance of the warning display were measured in each mode (the day mode and the night mode) (see FIG. 11). In FIG. 11, the present invention A corresponds to a case where a display mode of the liquid crystal display is a TN mode, the present invention B corresponds to a case where a display mode of the liquid crystal display is an MVA mode, and the present invention C corresponds to a case where a display mode of the liquid crystal display is an IPS mode.

In FIG. 11, the “CONTRAST” is equal to white luminance/black luminance, the “GRADATION EXPRESSION” indicates whether or not it is possible to carry out gradation expression with 0 to 64 gradations with respect to 8-bit image data (“YES” indicates that the gradation expression with 0 to 64 gradations is possible, and “NO” indicates that the gradation expression with 0 to 64 gradations is impossible), and the “DETERMINATION” indicates whether or not it is possible to easily distinguish between the image data for general display and the image data for warning display.

As is clear from FIG. 11, in any of the arrangements, each white luminance in the night mode can be made smaller than a corresponding white luminance in the day mode. Since no pseudo multi-gradation processing is carried out in each of the conventional examples, gradation expression with 0 to 64 gradations is impossible. Moreover, in each of the conventional examples, a circuit for determining the image data for warning display should have a complicated circuit configuration.

According to the arrangement of the present embodiment, the pseudo multi-gradation processing is carried out, and so gradation expression with 0 to 64 gradations is possible. Moreover, it is possible easily identify the image data for warning display since the maximum gradation value (i.e. gradation value 63) is used as a gradation value exclusively used for the image data for warning display.

As later described, the gradation calculator 22 can be arranged so as not to include the image data identification section 26, in a case where the gradation calculator 22 is arranged so that (i) image data having the maximum gradation value (e.g. gradation value 63) is uniformly subjected to gradation conversion with reference to the conversion table stored in the ROM 25 and (ii) the other image data is subjected to gradation conversion in which its gradation values are shifted to respective lower ones.

Out of the present inventions A through C, the present invention A (TN mode) has black luminance of 0.8, which is higher than those of the other display modes. This causes black floating (a graying of black level) especially in the night mode in which white luminance declines. On the other hand, black luminance can be reduced by employing the display mode like the present invention B (MVA mode) or the present invention C (IPS mode). Therefore, a liquid crystal display device of the present invention is preferably applied to a liquid crystal display device of an MVA mode or an IPS mode, and is more preferably applied to a liquid crystal display device of an MVA mode.

### Modification of Embodiment 1

The following description deals with a modification of the present embodiment. According to the modification, a combination of gradation values of red (R) pixel, green (G) pixel, and blue (B) pixel which constitute one (1) pixel is varied in various ways, by utilizing the fact that the maximum gradation value 63 is exclusively used for the image data for warning display. This allows the warning display to be carried out with use of any of more colors.

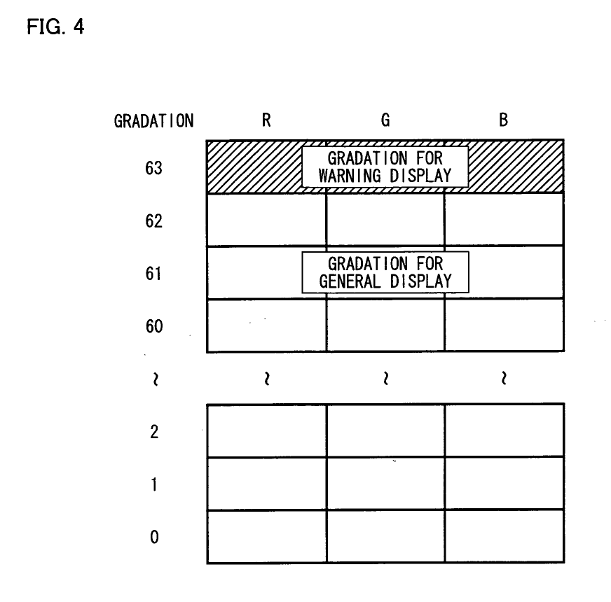

FIG. 4 shows a data structure of the image data D which is prepared by the instrument panel control system 17 in a case where the image data D is subjected to image processing which is carried out in the modification. As shown in FIG. 4, the maximum gradation value 63 of each of the RGB pixels is used for the image data for warning display, and gradation values 0 through 62 of each of the RGB pixels are used for the image data for general display.

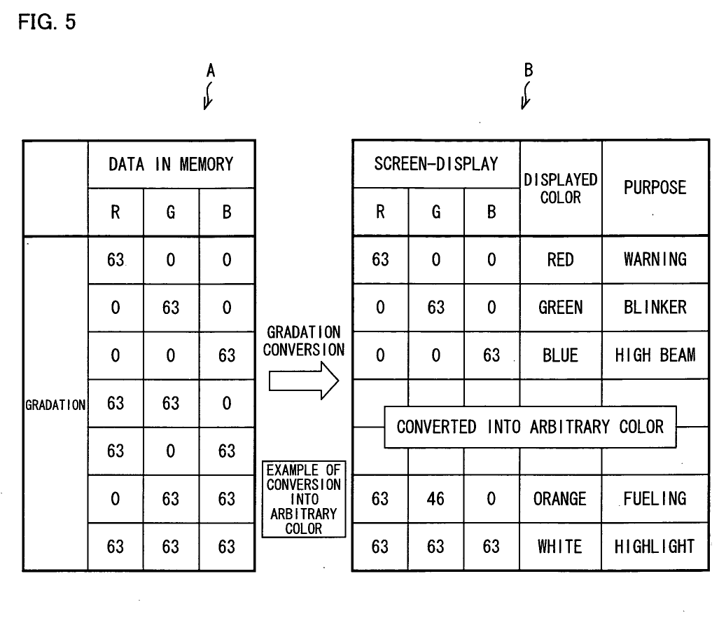

FIG. 5 shows an example of a result obtained in a case where the gradation calculator 22 carries out gradation conversion processing with respect to the image data shown in FIG. 4. The table A of FIG. 5 shows combinations of gradation values of one (1) pixel constituting the image data for warning display, which combinations are prepared by the CPU 32 of the instrument panel control system 17 and are then stored in a memory (video memory). The table B shown in FIG. 5 shows combinations of gradation values of the image data for warning display that have been subjected to gradation conversion processing in the gradation calculator 22.

As shown in the table A, there are seven combinations of gradation values which cause each of the gradations values of RGB pixels to be 0 or 63. The seven combinations are converted into respective combinations for expressing different colors (see table B), so that the warning display can be carried out with use of any of seven colors. Moreover, it is possible to change color in accordance with a type of the warning display, as shown in the table B for example. Such gradation value conversion can be carried out as long as the table A and the table B shown in FIG. 5 are stored, as respective conversion tables, in the ROM 25, for example.

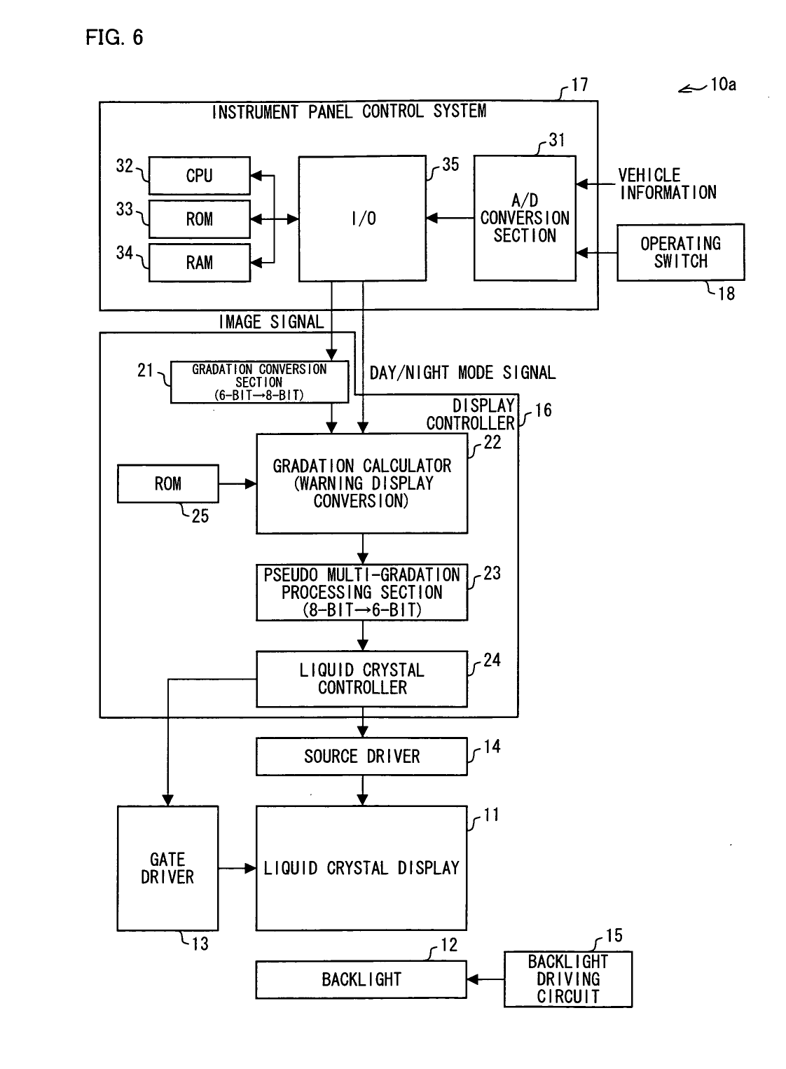

According to the modification, (i) an identification of the type of image data and (ii) a gradation value conversion which is carried out based on a result of such an identification are carried out only by arithmetic operation of the gradation calculator 22 that is carried out based on data stored in the ROM 25. This eliminates the need for the image data identification section 26 shown in FIG. 1. FIG. 6 shows an arrangement of a liquid crystal display device 10a in accordance with the present modification. The liquid crystal display device 10a is different from the liquid crystal display device 10 only in that the gradation calculator 22 includes no image data identification section 26. Except for this, the liquid crystal display device 10a is identical to the liquid crystal display device 10 shown in FIG. 1, and therefore the arrangement of the liquid crystal display device 10a is not described in detail.

The description has dealt with an example in which the maximum gradation value 63 is exclusively used for the warning display. However, the present invention is not limited to this. For example, even in a case where the minimum gradation value 0 is exclusively used for the warning display, a similar effect can be obtained by similar processing.

In a case where the gradation value 63 is used as the gradation value exclusively used for the image data for warning display, and in a case where the gradation calculator (gradation conversion section) does not carry out gradation conversion processing for reducing luminance of a displayed image, like a case where the day mode is selected, the gradation calculator 22 can further carry out gradation conversion processing with respect to the image data for general display so that luminance corresponding to the gradation value 62 (the maximum gradation value−1), which is the maximum gradation value in the image data for general display, becomes identical to that corresponding to the gradation value 63. This can prevent a deterioration in luminance of the general display in the day mode. Similarly, in a case where a gradation value 0 is used as the gradation value exclusively used for the warning display, similar processing is carried out so that luminance corresponding to the gradation value 1 (the minimum gradation value+1), which is the minimum gradation value in the image data for general display, becomes identical to that corresponding to the gradation value 0. Thus, a similar effect can be obtained.

### Embodiment 2

Here, Embodiment 2 of the present invention is described below. According to a liquid crystal display device of the present embodiment, (i) the maximum gradation value and (the maximum gradation value−1) are used as gradation values exclusively used for image data for warning display and (ii) the image data is subjected to a gradation conversion in which gradation values of image data including (the maximum gradation value−1) are converted into respective gradation values which cause orange color to be displayed.

The liquid crystal display device of the present embodiment has a substantially similar arrangement to the liquid crystal display device 10 shown in FIG. 1. Therefore, the arrangement of the liquid crystal display device of the present embodiment is described with reference to FIG. 1, and only differences from the liquid crystal display device 10 are described. Note, however, that it is possible to eliminate the image data identification section 26 in the liquid crystal display device of the present embodiment. This is because the gradation calculator 22 carries out both of the gradation conversion processing and the identification of image data.

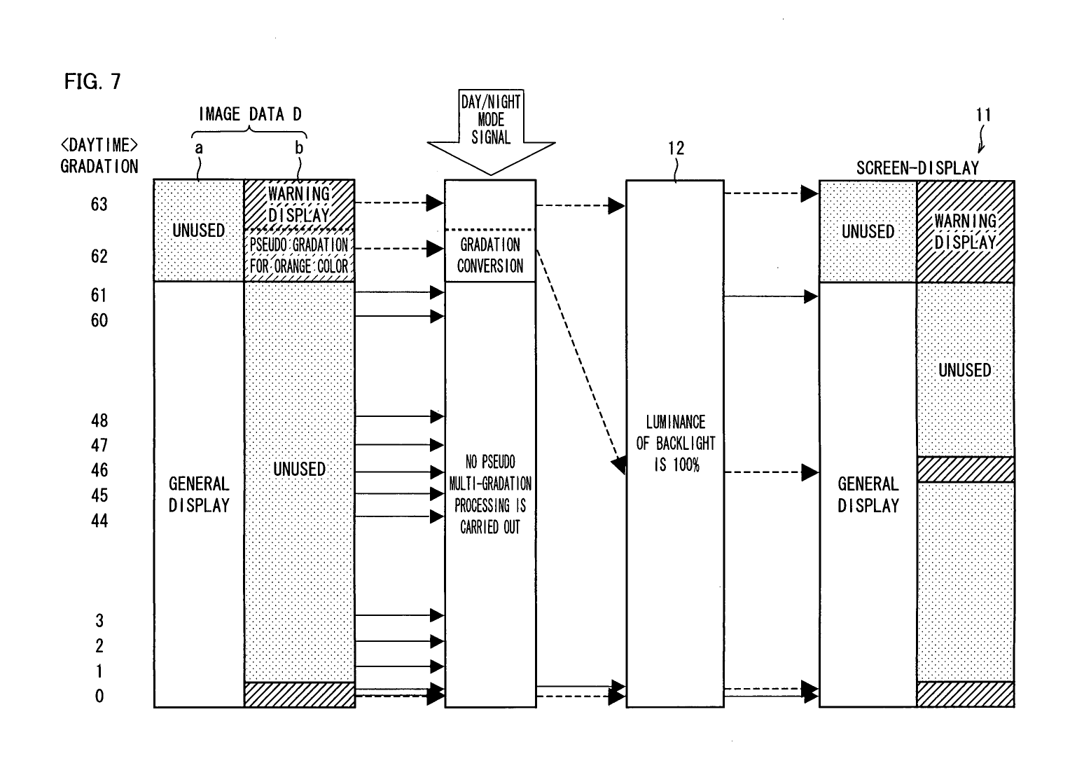

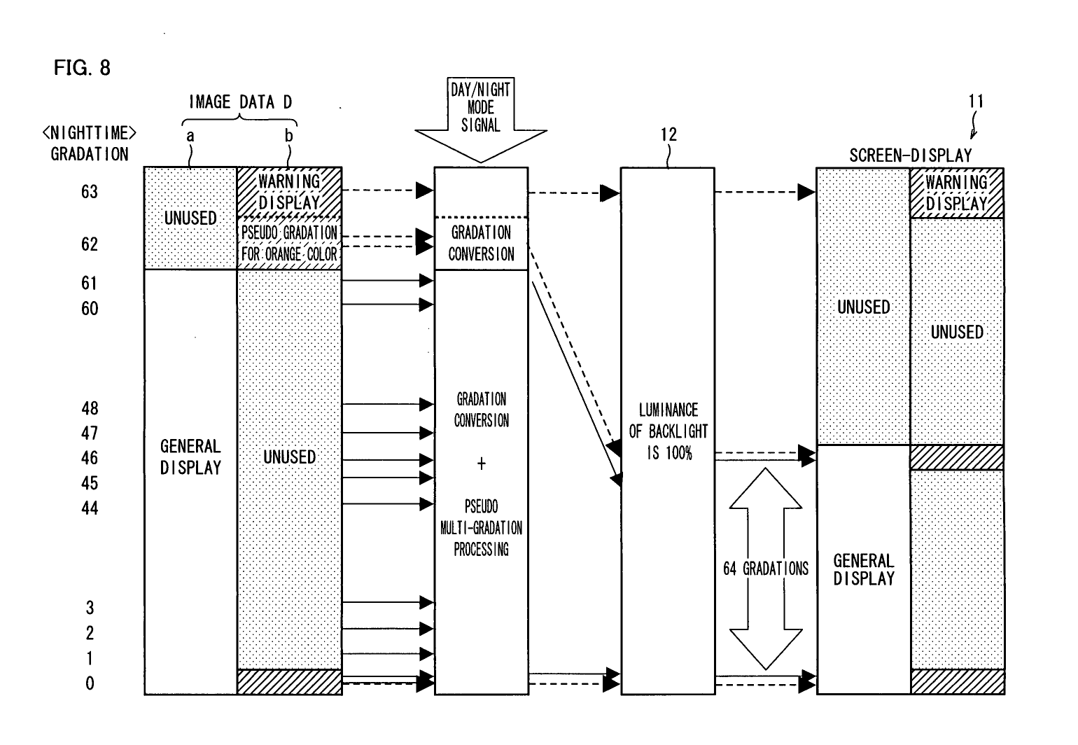

FIG. 7 shows an example of a flow of image data processing which is carried out in a day mode by the liquid crystal display device 10 of the present embodiment. FIG. 8 shows an example of a flow of image data processing which is carried out in a night mode by the liquid crystal display device 10 of the present embodiment.

Left parts of FIGS. 7 and 8 each show a data structure of image data (image signal) D supplied from an instrument panel control system 17. The image data D includes image data a (second image data) for general display and image data b (first image data) for warning display. Only the gradation values 0 through 61 are used for the image data a for general display out of the image data D which is supplied from the instrument panel control system 17 to the display controller 16, and therefore the maximum gradation value 63 and the gradation value 62 (i.e. the maximum gradation value−1) are not used (see FIG. 7). In contrast, only the gradation values 0, 62, and 63 are used for the image data b for warning display, and therefore the other gradation values are not used. The gradation value 62 is used for a pixel for orange display. Specifically, a combination of gradation values of one (1) pixel causing orange color to be displayed is (R=63, G=62, B=0).

Upon receipt of the image data D from an I/O 35 of the instrument panel control system 17, a gradation conversion section 21 once converts the image data D, which is 6-bit image data, into 8-bit image data in preparation for pseudo multi-gradation processing which is carried out later.

The image data D which has been converted into the 8-bit image data by the gradation conversion section 21 is supplied to a gradation calculator 22 (image data identification section, gradation conversion section). The gradation calculator 22 determines, based on a day/night mode signal supplied from the instrument panel control system 17, whether or not gradation conversion processing for reducing luminance of a displayed image is carried out, as in Embodiment 1.

The gradation calculator 22 identifies, as image data for warning display, data having the gradation value 63, and then outputs such data as it is without carrying out gradation conversion processing. The gradation calculator 22 also identifies, as image data for warning display, image data having the gradation value 62, and carries out gradation conversion with respect to such image data with the use of a conversion table stored in the ROM 25 so that orange color is displayed. The gradation calculator 22 identifies the other image data as image data for general display, and then carries out conversion processing with respect to such image data so that gradation values of such image data are shifted to respective lower gradation values. Subsequent processing is similar to that in Embodiment 1, and therefore is not explained repeatedly.

According to the arrangement of the present embodiment, the gradation calculator 22 not only can distinguish between the image data a for general display and the image data b for warning display, but also can carry out image processing for each image data to be processed. That is, the gradation calculator 22 functions as an image data identification section and a gradation conversion section. This allows image processing to be carried out with a simpler arrangement.

The present embodiment has dealt with an example in which two gradation values, i.e., the maximum gradation value and (the maximum gradation value−1) are used as gradation values exclusively used for image data for warning display. However, the present invention is not limited to this. The following (n+1) gradation values (n is any integer in a range of 1 to 10) can be used as gradation values exclusively used for the image data for warning display: the maximum gradation value, (the maximum gradation value−1), . . . and (the maximum gradation value−n). In a case where image data having any one of these gradation values is subjected to gradation conversion processing so that gradation values used for the image data are converted into respective gradation values which cause an arbitrary color to be displayed, it is possible to carry out the warning display with use of any of more colors.

Alternatively, the following gradation values can be used as gradation values exclusively used for the image data for warning display: the minimum gradation value, (the minimum gradation value+1), . . . (the minimum gradation value+n) (n is any integer in a range of 1 to 10). Also in this case, image processing can be carried out in a similar manner to the case where the maximum gradation value is used.

### Embodiment 3

The embodiments 1 and 2 have dealt with a case where the present invention is applied to a display device which does not have a function of adjusting luminance of a backlight. However, the present invention is not limited to this, and therefore can be applied to a display device which has the function of adjusting luminance of the backlight.

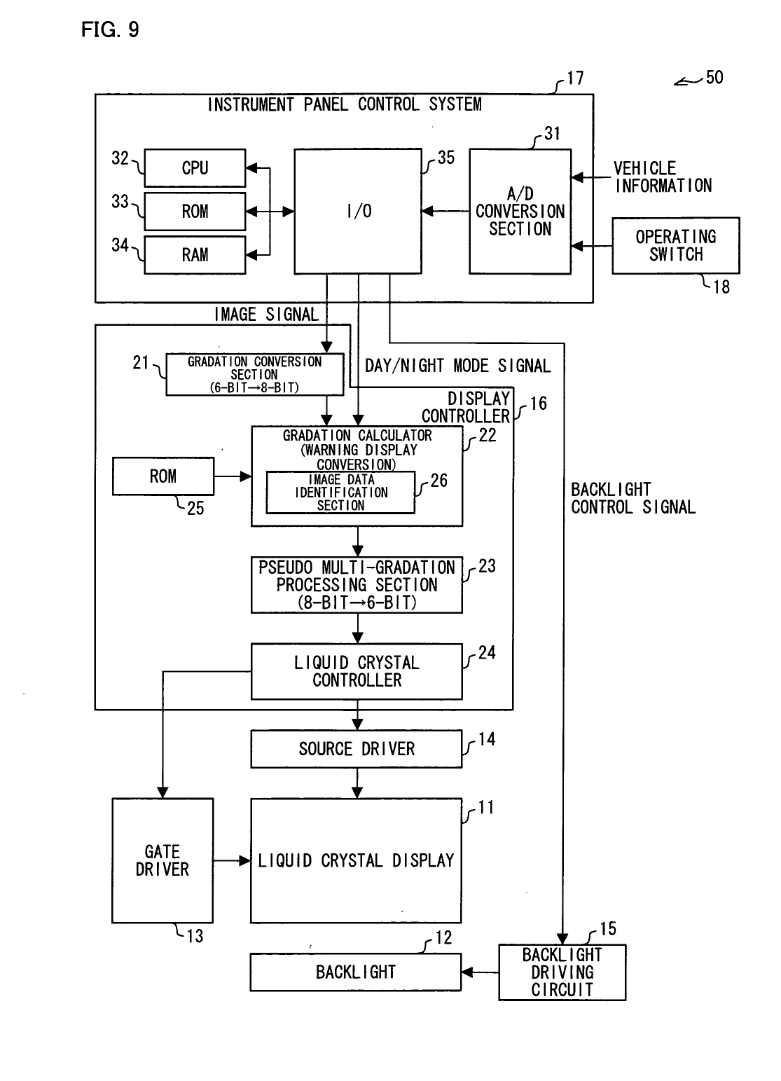

In view of the circumstances, Embodiment 3 of the present invention deals with a liquid crystal display device which has a backlight adjusting function. FIG. 9 shows an arrangement of a liquid crystal display device 50 of the present embodiment. According to the liquid crystal display device 50, a backlight driving circuit 15 changes luminance of a backlight 12 in response to a backlight control signal supplied from the instrument panel control system 17 (see FIG. 9).

The luminance of the backlight 12 of the liquid crystal display 50 is controlled in the daytime and in the nighttime as follows.

The instrument panel control system 17 receives, as vehicle information, information concerning ambient brightness detected by an illuminance sensor provided in a vehicle. Then, a CPU 32 of the instrument panel control system 17 determines, based on the vehicle information, whether or not the ambient brightness is not less than a predetermined value. In a case where it is determined that the ambient brightness exceeds the predetermined value, a signal (backlight control signal) instructing a day mode is generated. In contrast, in a case where it is determined that the ambient brightness is not more than the predetermined value, a signal (backlight control signal) instructing a night mode is generated. The backlight control signal is supplied to the backlight driving circuit 15 via the I/O 35.

Switching of the day/night mode signal between the night mode and the day mode can be automatically carried out based on a result detected by the illuminance sensor as described above. Note, however, that such switching can be carried out based on ON/OFF of a switch for a front position light or a headlamp (headlight) (for example, the image display mode is changed from the day mode to the night mode while the switch is being turned ON, whereas the image display mode is changed from the night mode to the day mode while the switch is being turned OFF).

In the day mode (in a case where the backlight control signal instructs the day mode), the luminance of the backlight 12 is controlled in response to the backlight control signal so that the backlight 12 irradiates a liquid crystal display 11 with the rated power (100 percent power). This allows an image to be displayed more brightly.

Meanwhile, in the night mode (in a case where the backlight control signal instructs the night mode), the luminance of the backlight is reduced to 50%. Namely, the brightness of the screen in the night mode is about one-half of that in the day mode, even if image display is carried out with use of 64-gradation which is used in the daytime (see the right parts of FIGS. 3 and 8). This can reduce especially luminance of a low-gradation region (e.g. black display area).

The other arrangement of the liquid crystal display device 50 is identical to that of the liquid crystal display device 10 shown in FIG. 1, and is therefore not described repeatedly. The embodiment 3 has dealt with a case where the luminance of the backlight is changed in the daytime and in the nighttime. However, the present invention is not necessarily limited to this. It is also possible that a user appropriately determines how the luminance of the backlight is changed, in accordance with environment and intended purpose.

### Embodiment 4

Here, Embodiment 4 of the present invention is described below. Each of the above embodiments has dealt with the case where a display controller 16 includes the gradation conversion section 21 and the gradation calculator 22 which carry out processing which is carried out prior to the pseudo multi-gradation processing. In contrast, the present embodiment deals with an arrangement in which a CPU 32 of an instrument panel control system 17 carries out such processing which is carried out by the gradation conversion section 21 and the gradation calculator 22.

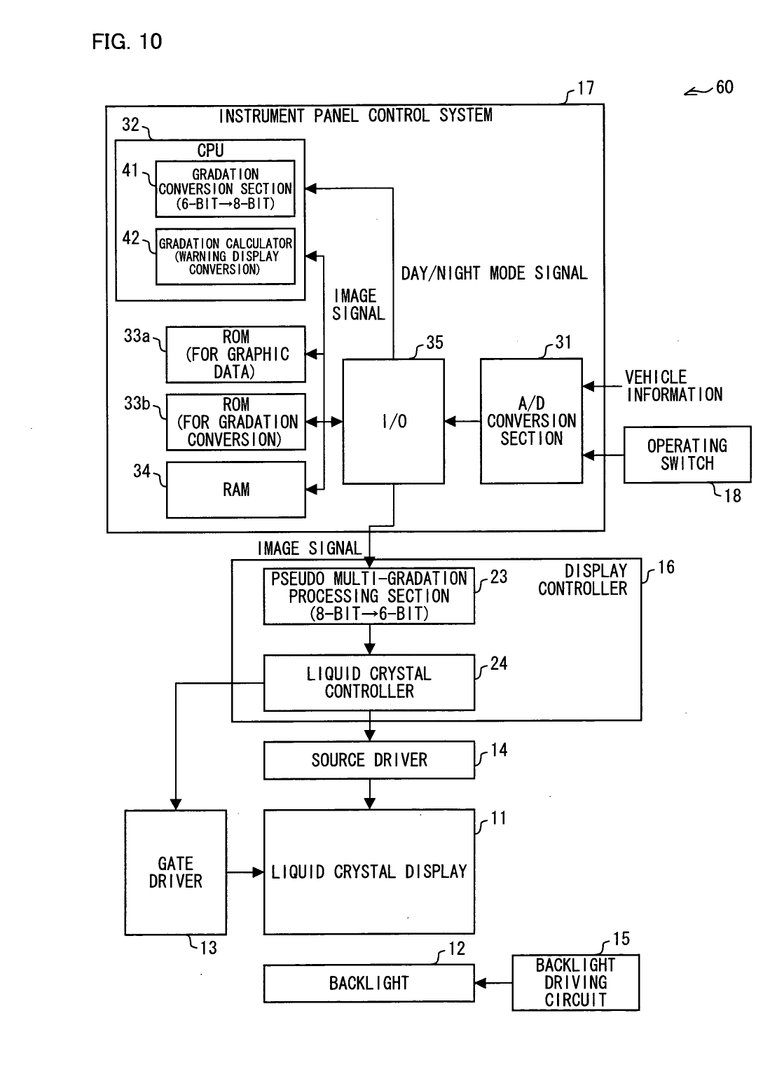

FIG. 10 shows an arrangement of a liquid crystal display device 60 of the present embodiment. According to the liquid crystal display device 60, the CPU 32 of the instrument panel control system 17 includes sections which carry out processing in preparation for pseudo multi-gradation processing, i.e., (i) a gradation conversion section 41 which converts 6-bit image data into 8-bit image data and (ii) a gradation calculator 42 which carries out gradation value conversion processing in which gradation values of image data are shifted to respective lower ones so as to reduce luminance of a displayed image.

The instrument panel control system 17 also includes a ROM 33b which is used during gradation conversion carried out by the gradation calculator 42. Two kinds of ROMs, i.e., a ROM 33a in which graphic data is stored and the ROM 33b which is used during the gradation conversion are thus provided. The gradation calculator 42 carries out gradation conversion processing with respect to image data for warning display based on information stored in the ROM 33b, as in the Embodiment 2.

Specifically, the gradation calculator 42 reads out, from the ROM 33a, the graphic data to be displayed on the liquid crystal display device 60, determines whether the graphic data is image data for warning display or image data for general display, and then carries out, in response to a day/night mode signal, gradation calculation with reference to table conversion data stored in the ROM 33b. Then, the gradation calculator 42 carries out gradation conversion with respect to all the graphic data and causes the graphic data to be temporarily stored in a RAM 34. Similar to conventional graphic display, the data thus stored in the RAM 34 is read out from the RAM 34, and is then supplied to the display controller 16. The data thus supplied to the display controller 16 is subjected to pseudo multi-gradation processing so as to be converted into an actual liquid crystal display signal. Thus, an image can be displayed.

Processing which is carried out by each block constituting the liquid crystal display device 60 is identical to that of the liquid crystal display device 10 shown in FIG. 1, and therefore is not described repeatedly. Although FIG. 10 dose not show an image data identification section in the liquid crystal display device 60, the image data identification section is actually provided in the gradation calculator 41. The image data identification section of the gradation calculator 41 distinguishes between image data for warning display and image data for general display.

According to the present embodiment, the instrument panel control system 17 can intensively include (i) the ROM 33a in which graphic data is stored and (ii) the ROM 33b used in gradation conversion. This allows a device structure to be simplified.

Note that it is also possible for a pseudo multi-gradation processing section 23 to be provided in the instrument panel control system 17. Note, however, that it is more preferable, from the viewpoint of simplification of the arrangement, that the pseudo multi-gradation processing section 23 be provided, so as to be integrated with a liquid crystal controller, in the display controller. This is because pseudo multi-gradation processing affects driving control of liquid crystal.

The present invention is not limited to the description of each of the embodiments above, but may be altered by a skilled person within the scope of the claims. An embodiment based on a proper combination of technical means disclosed in different embodiments is encompassed in the technical scope of the present invention.

According to a liquid crystal display device of the present invention, the first image data has a gradation value exclusively used for the first image data, the liquid crystal display device including: an image data identification section which determines whether image data to be processed is the first image data or the second image data by judging whether or not the image data has the gradation value exclusively used for the first image data; and a gradation conversion section which carries out gradation conversion processing with respect to the image data so that luminance of a displayed image is reduced in a case where ambient brightness declines, the gradation conversion section carrying out the gradation conversion processing with respect to image data, which has been determined to be the second image data by the image identification section, so as to reduce the luminance of the image data.

According to an image processing method of the present invention, the first image data has a gradation value exclusively used for the first image data, the image processing method including the steps of: (a) determining whether image data to be processed is the first image data or the second image data by judging whether or not the image data has the gradation value exclusively used for the first image data; and (b) carrying out gradation conversion processing with respect to the image data so that luminance of a displayed image is reduced in a case where ambient brightness declines, in the step (b), the gradation conversion processing is carried out with respect to image data, which has been determined to be the second image data in the step (a), so as to reduce the luminance of the image data.

According to the present invention, it is possible to easily distinguish between the first image data and the second image data. This allows only the second image data to be subjected to image processing, such as pseudo multi-gradation processing, which suppresses a deterioration in image quality. This makes it possible to realize a liquid crystal display device, without detriment to visibility, in which (i) a deterioration in image quality of general display displayed based on the second image data can be suppressed and (ii) display luminance is kept high in case of information of high importance such as warning display, for example.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

A liquid crystal display device of the present invention is suitably used as a liquid crystal display device for use in a vehicle.

1. A liquid crystal display device which causes an image to be displayed on a display panel in response to an image signal including first image data for displaying information of high importance and second image data for displaying information other than the information of high importance,
the first image data having a gradation value exclusively used for the first image data,
said liquid crystal display device, comprising:
an image data identification section which determines whether image data to be processed is the first image data or the second image data by judging whether or not the image data has the gradation value exclusively used for the first image data; and
a gradation conversion section which carries out gradation conversion processing with respect to the image data so that luminance of a displayed image is reduced in a case where ambient brightness declines,
the gradation conversion section carrying out the gradation conversion processing with respect to image data, which has been determined to be the second image data by the image identification section, so as to reduce the luminance of the image data.

2. The liquid crystal display device according to claim 1, wherein the gradation conversion section carries out processing which causes the gradation value of the image data to be shifted to a lower gradation value,
said liquid crystal display device, further comprising:
a pseudo multi-gradation processing section which carries out pseudo multi-gradation processing with respect to the second image data in a case where the gradation conversion section carries out the gradation conversion processing with respect to the second image data.

3. The liquid crystal display device according to claim 1, wherein:
a maximum gradation value or a minimum gradation value is used as the gradation value exclusively used for the first image data.

4. The liquid crystal display device according to claim 1, wherein:
the gradation conversion section selects whether or not it carries out the gradation conversion processing depending on whether said device is in a night mode or in a day mode, and carries out the gradation conversion processing in the night mode.

5. The liquid crystal display device according to claim 1, wherein:
the liquid crystal display device is for use in a vehicle, and
the first image data is image data for warning display.

6. The liquid crystal display device according to claim 1, wherein:
the liquid crystal display device is a vertical alignment mode liquid crystal display device.

7. The liquid crystal display device according to claim 1, wherein:
a maximum gradation value, (the maximum gradation value−1), . . . (the maximum gradation value−n) (n is any integer in a range of 1 to 10) are used as gradation values exclusively used for the first image data, and
the gradation conversion section further carries out gradation conversion processing with respect to each image data having a corresponding one of the gradation values exclusively used for the first image data so that a conversion to a gradation value which causes an arbitrary color to be displayed is carried out.

8. The liquid crystal display device according to claim 1, wherein:
a minimum gradation value, (the minimum gradation value+1), . . . (the minimum gradation value+n) (n is any integer in a range of 1 to 10) are used as gradation values exclusively used for the first image data, and
the gradation conversion section further carries out gradation conversion processing with respect to each image data having a corresponding one of the gradation values exclusively used for the first image data so that a conversion to a gradation value which causes an arbitrary color to be displayed is carried out.

9. The liquid crystal display device according to claim 3, wherein:
in a case where (i) the maximum gradation value is used as the gradation value exclusively used for the first image data and (ii) the gradation conversion section does not carry out the gradation conversion processing for reducing the luminance of the displayed image, the gradation conversion section further carries out a conversion of gradation value with respect to the second image data so that luminance corresponding to (the maximum gradation value−1) becomes identical to that corresponding to the maximum gradation value.

10. The liquid crystal display device according to claim 3, wherein:
in a case where (i) the minimum gradation value is used as the gradation value exclusively used for the first image data and (ii) the gradation conversion section does not carry out the gradation conversion processing for reducing the luminance of the displayed image, the gradation conversion section further carries out a conversion of gradation value with respect to the second image data so that luminance corresponding to (the minimum gradation value+1) becomes identical to that corresponding to the minimum gradation value.

11. The liquid crystal display device according to claim 1, further comprising:
a backlight which irradiates the display panel with light; and
a backlight driving circuit which controls luminance of the backlight.

12. An image processing method for use in a liquid crystal display device which causes an image to be displayed on a display panel in response to an image signal including first image data for displaying information of high importance and second image data for displaying information other than the information of high importance,
the first image data having a gradation value exclusively used for the first image data,
said image processing method comprising the steps of:
(a) determining whether image data to be processed is the first image data or the second image data by judging whether or not the image data has the gradation value exclusively used for the first image data; and
(b) carrying out gradation conversion processing with respect to the image data so that luminance of a displayed image is reduced in a case where ambient brightness declines,
in the step (b), the gradation conversion processing is carried out with respect to image data, which has been determined to be the second image data in the step (a), so as to reduce the luminance of the image data.

13. The image processing method according to claim 12, wherein:
the step (b) carries out processing which causes the gradation value of the image data to be shifted to a lower gradation value,
said image processing method, further comprising the step of:
(c) carrying out pseudo multi-gradation processing with respect to the second image data in a case where the gradation conversion processing is carried out, in the step (b), with respect to the second image data.

14. The image processing method according to claim 12, wherein:
a maximum gradation value or a minimum gradation value is used as the gradation value exclusively used for the first image data.

15. The image processing method according to claim 12, wherein:
in the step (b), it is selected whether to carry out the gradation conversion processing depending on whether the liquid crystal display device is in a night mode or in a day mode, and the gradation conversion processing is carried out in the night mode.

16. The image processing method according to claim 12, wherein:
a maximum gradation value, (the maximum gradation value−1), . . . (the maximum gradation value−n) (n is any integer in a range of 1 to 10) are used as gradation values exclusively used for the first image data, and
in the step (b), gradation conversion processing is further carried out with respect to each image data having a corresponding one of the gradation values exclusively used for the first image data so that a conversion to a gradation value which causes an arbitrary color to be displayed is carried out.

17. The image processing method according to claim 12, wherein:
a minimum gradation value, (the minimum gradation value+1), . . . (the minimum gradation value+n) (n is any integer in a range of 1 to 10) are used as the gradation value exclusively used for the first image data, and
in the step (b), gradation conversion processing is further carried out with respect to each image data having a corresponding one of the gradation values exclusively used for the first image data so that a conversion to a gradation value which causes an arbitrary color to be displayed is carried out.
